(19) United States
(12) Patent Application Publication
(10) Pub. No.: US 2010/0057646 A1
(43) Pub. Date: Mar. 4, 2010

(54) Intelligent Dashboards With Heuristic Learning

(76) Inventors: Neil A. Martin, Encino, CA (US); Farzad D. Buxey, Marina Del Rey, CA (US); Vesselin Zlatev, Aliso Viejo, CA (US)

Correspondence Address: ST. ONGE STEWARD JOHNSTON & REENS, LLC, 986 BEDFORD STREET, STAMFORD, CT, 06905-5619, US

(21) Appl. No.: 12/617,328

(22) Filed: Nov. 12, 2009

Related U.S. Application Data
(63) Continuation-in-part of application No. 12/036,287, filed on Feb. 24, 2008.

(51) Int. Cl. G06N 5/02

(52) U.S. Cl. 706/11

(57) ABSTRACT

An intelligent method for displaying patient data is described. Patient data may be collected from a variety of reporting systems. The method normalizes the patient data so that it may be compared to a set of rules used to define various conditions. The method identifies a medical or non-medical condition based on the patient data and set of rules. Based on the identified condition, the method then recommends a user interface for displaying patient data to a user. A user may accept or reject the recommended user interface and/or may select a different user interface. The users' selections are collected for automated analysis in order to improve the recommendations made to other users based on similar patient or user data.

### CLAIM BENEFIT OF PRIOR APPLICATION

This patent application is a continuation-in-part of the U.S. patent application entitled “Intelligent Dashboards,” having Ser. No. 12/036,287, filed on Feb. 24, 2008. This application is incorporated herein by reference.

### CROSS-REFERENCE TO RELATED APPLICATION

This Application is related to the U.S. patent application entitled “Drill Down Clinical Information Dashboard,” having Ser. No. 12/036,281, filed on Feb. 24, 2008. This application is incorporated herein by reference.

### FIELD OF THE INVENTION

The invention is directed towards a clinical information system that provides intelligent dashboards for viewing patient data. In particular, the invention involves recommending dashboards to users and automatically collecting and analyzing heuristic statistics data based on the user selections to improve the recommendation procedures.

### BACKGROUND OF THE INVENTION

In recent years, hospitals have increased the amount of information they produce about each patient in digital form to an extent that would be overwhelming to a human being trying to cope with every bit of that information. For example, a patient's heart rate or blood pressure might be continuously monitored with a new value generated several times a minute.

Accordingly, systems for displaying such data have been developed. Some of these systems take the form of dashboards for computer or other electronic displays for displaying specific information about a patient. Unfortunately, in many cases, the overwhelming amount of raw data has been replaced by an overwhelming number of different options as to which dashboard will provide the most useful information about a patient at any given time. Therefore, a need has arisen for a system that helps a user select an appropriate dashboard to use to display information about a selected patient.

In addition, systems for collecting such patient data must be able to receive and process data from a variety of external reporting systems. Thus, there is a need for a data collection system that automatically collects patient data from external reporting systems and normalizes the data for use within the dashboard selection system.

Furthermore, users of such a dashboard display system may find that they prefer an alternative dashboard (or a lower-ranked dashboard if more than one is recommended) to the dashboard (or dashboards) recommended by the system. Users may also prefer to alter the criteria that causes the system to prompt the user to select a dashboard. Therefore, there is a need for a system that automatically collects and analyzes heuristic statistics in order to refine and improve the criteria that prompts a user to select a dashboard, the recommendation of the dashboard (or dashboards), and/or other system parameters.

### SUMMARY OF THE INVENTION

Some embodiments of the invention provide an intelligent method for displaying patient data. The method identifies a situational condition relating to a patient or user of the system. Based on the identified condition, the method then identifies a user interface for displaying patient data to a user. In some embodiments, a condition could be a condition determined by a set of vital statistics, or by any other piece of information, or collection of information relating to the patient or the person viewing the dashboard. The condition could be whether the user viewing the patient data is a doctor or nurse, or what kind of doctor (e.g. neurologist or osteopath), what department the patient is in (e.g. ICU, cardiology ward, etc) or any other fact about the patient, the user, the location or anything else deemed relevant to selecting an appropriate dashboard or any combination of such variables.

In some embodiments, the method displays the user interface to the user automatically upon identification of the condition. In other embodiments, the method displays the identified user interface in a list of recommended user interfaces. In these embodiments, the user can then select the identified user interface from the recommended list in order to view the identified user interface. The method of some embodiments then receives a user selection of a user interface from the recommended list. The method then displays the selected user interface and patient information in the selected user interface according to parameters of the selected user interface. In other embodiments, the method automatically chooses a user interface based on an identified condition rather than presenting recommended user interfaces.

Some embodiments perform normalization of data that is provided by different external reporting systems. The normalization process may include scaling the data, filling in missing values based on certain rules, and/or eliminating (or modifying) data points that fall outside pre-determined reporting thresholds. Normalization may be used in some cases so that existing rules (and their associated conditions) may be applied to data from different sources without having to modify the rules.

In some embodiments, data related to user selections is automatically collected and analyzed to improve future recommendations or parameters. The analysis may include performing calculations on the collected data to determine statistically significant relationships between a set of inputs to the system and the selections (or modifications) made by users. If statistically significant relationships are identified between the inputs and the user selections, the recommendation algorithms (or other parameters) may be altered so that each user is more likely to receive her preferred dashboard (or other system output) based on a set of selection criteria.

Some embodiments apply the modified parameters to other patients and users as appropriate. For instance, when the system determines that a user has selected a particular dashboard (or other parameter) based on certain characteristics of a particular patient, the system may identify other patients who share those characteristics and then recommend the particular dashboard to other users when they are evaluating patients who share those characteristics.

### BRIEF DESCRIPTION OF THE DRAWINGS

The novel features of the invention are set forth in the appended claims. However, for purpose of explanation, several embodiments of the invention are set forth in the following figures.

FIG. 1 illustrates the system of some embodiments.

FIG. 2 illustrates four different dashboards.

FIGS. 3a-3b illustrate a clinical information system (CIS) application user interface of some embodiments.

FIG. 4 illustrates an intelligent dashboard process.

FIG. 5 illustrates some components of the system in some embodiments.

FIG. 6 illustrates a graphical user interface for providing recommendations.

FIG. 7 illustrates a software block diagram of some embodiments.

FIG. 8 illustrates a rules editing process.

FIG. 9 illustrates a rules editor of some embodiments.

FIG. 10 illustrates a process of editing and saving a dashboard.

FIG. 11 illustrates a sequential modification of a dashboard.

FIG. 12 illustrates a modification of the dashboard of FIG. 3b.

FIG. 13 illustrates a table of permissions of some embodiments.

FIG. 14 illustrates an example of a recommendation list with a public dashboard and attribution.

FIG. 15 illustrates a software block diagram of a clinical data manager of some embodiments that implements a normalization process described in reference to FIG. 16 and machine learning and feedback processes described in reference to FIGS. 17-19.

FIG. 16 illustrates an automated normalization process of some embodiments.

FIG. 17 illustrates an automated process of some embodiments used to gather and analyze data for the heuristic statistics database and apply the data to future patients.

FIG. 18 illustrates an adaptive, automated process for triggering display of a dashboard.

FIG. 19 illustrates an automated dashboard recommendation process with feedback of some embodiments.

FIG. 20 illustrates a graphical user interface of some embodiments for providing recommendations after a dashboard triggering event.

FIGS. 21 and 22 illustrate the graphical user interface of FIG. 20 after machine learning due to different types of user feedback.

FIG. 23 illustrates some components of the system in an alternate embodiment.

FIG. 24 illustrates a computer system with which some embodiments of the invention are implemented.

### DETAILED DESCRIPTION OF THE INVENTION

In the following description, numerous details are set forth for purpose of explanation. However, one of ordinary skill in the art will realize that the invention may be practiced without the use of these specific details. For instance, the techniques described below are described in a specified order, but other embodiments may change the order of the operations while still embodying the current invention.

Some embodiments of the invention provide an intelligent method for displaying patient data. The method identifies patient conditions (including non-medical conditions such as the primary physician's department or location of a user looking at information about the patient). Based on the identified condition, it then identifies a user interface for displaying patient data to a user.

In the discussion below, the term dashboard is used to refer to a user interface (UI) that is used for displaying patient data. In the example below, a dashboard is a collection of window panes, with each window pane providing one or more views of a set of patient data (e.g., patient clinical data). Several examples of dashboards are provided in Section II. Before providing these examples, Section I describes one environment for implementing the intelligent UI selection methodology of some embodiments of the invention.

After the providing several dashboard examples in Section II, Section III describes the intelligent dashboard selection methodology of some embodiments in further detail. In some embodiments, this methodology has a knowledge base and a library of dashboards that enhanced over time based on user feedback. Section IV then describes the knowledge base, the library of dashboards, and improvements to them based on user feedback. Next, Section V describes the normalization of data provided by external reporting systems. Following that discussion, Section VI describes the automated system learning using user feedback of some embodiments. That description is followed in Section VII by a discussion of alternate embodiments of the invention. Lastly, Section VIII describes a computer system that implements some embodiments of the invention.

### I. Overview

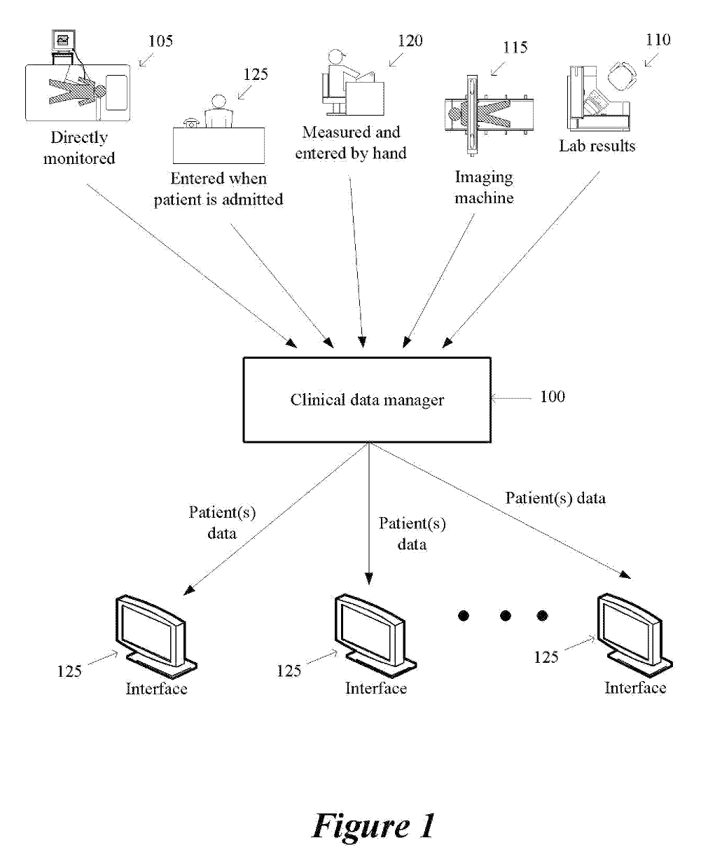

FIG. 1 illustrates a clinical data manager 100 in which some embodiments of the invention are implemented. The clinical data manager 100 collects patient data from various sources. In some embodiments, the patients may be in one unit of a hospital, in one hospital, or in several hospitals. As shown in FIG. 1, the collected data can come from a variety of sources, including sensors 105, lab tests 110, scans 115, recordings measured by medical personnel 120, information gathered when the patient is admitted and entered into an interface 125, or other sources of information about the patient or the patient's medical data.

The clinical data manager 100 receives, normalizes, analyzes, stores and/or aggregates the patient data. It performs these functions for the purposes of gathering data about individual patients, as a snapshot of a patient's data or as a record of the data over time. These operations also allow the system to compare statistics among patients (in some cases including the change in statistics of each patient) for various reasons, e.g., in order to efficiently allocate medical resources.

As noted, normalization is one of the operations performed by the clinical data manager. Normalization of the patient data may involve receiving the data from an external reporting system. Some embodiments scale the data, use rules to fill in missing values, and/or eliminate data points outside of pre-set threshold values as part of the normalization process.

Through various interfaces 125, the clinical data manager 100 reports data, disseminates data, and/or issues alerts to users based on this data. In some embodiments, these interfaces are different from each other depending on the job of the user within the medical system (e.g. doctor or nurse, what kind of doctor, etc.), the particular location in which the interfaces are displayed (e.g. cardiac ICU or coma ward), and the momentary needs of the individual user and/or patient. In the illustrated embodiment of FIG. 1, an interface 125 can be used for entering patient data when the patient is admitted, in other embodiments, different systems are used for entering patient admission data and for viewing patient data.

As mentioned above, some embodiments provide a methodology for automatically selecting an interface from among several interfaces (or dashboards) based on various conditions. As further described below, the interface selected can also be based on data relating to the patient (including medical and non-medical data), the identity of the user viewing the patient data, the ward of the hospital in which the user is when he wants to view the patient's data and on other factors not directly related to the individual patient, but related to those trying to access the data about the patient or other circumstances surrounding the attempt to access the data (e.g. time of day, etc.). In some embodiments, the information gathered by medical personnel 120 can be entered into an interface 125.

In some embodiments, the dashboard displays information that includes those data required to assess the severity of the condition, the trend (improving or deteriorating) of the condition, the cause of the condition, and/or the secondary consequences of the condition (e.g. on other organ systems). Furthermore, the dashboard provides the data that is required to determine an appropriate response. An appropriate response might include the ordering of additional lab tests or other diagnostic tests, ordering or changing medication, or scheduling invasive procedures or surgery.

In some embodiments, the dashboard displays information that includes established treatments, guidelines or protocols. The information may come from public reference sources or from customized intramural institutional policies. For instance, if the condition is hyperglycemia and the particular hospital has a policy for how to treat hyperglycemia, then a user can configure a dashboard to display that policy in a window of the dashboard. In some embodiments, the policy displayed in the dashboard is linked to a repository of policies, so when the policy is changed in the repository, the policy displayed when the dashboard is opened also changes.

In some embodiments, the information provided by an intelligent dashboard and the specific mode of display of the information in the intelligent dashboard are configured to answer the question “given this condition, what else would a health care provider (e.g. a nurse or doctor) need to see in order to fully assess the condition and respond appropriately?”

Accordingly, in some embodiments, the dashboard displays information where the information and the mode of displaying that information are specifically designed and configured with intent to follow the typical train of thought and sequence of assessment that a highly experienced expert clinician would follow, or to follow established best practices.

Where a prior art dashboard gives a menu of options that is the same no matter what (e.g. general categories of information). The intelligent dashboard of some embodiments decides what the most relevant data are and how to display them. Once the system identifies a condition the system brings up the information relevant to that condition quickly and easily (e.g. without needing to click several times each in several different windows to pull up the relevant data). Out of the massive array of data that a user could pull up from a myriad of menus, sub-menus and sub-sub-menus, the intelligent dashboard system pushes the appropriate data to the front in the manner most relevant to the user.

For instance, if a particular doctor wants to see certain types of information every time he logs in to the ICU, the information may be automatically displayed in the various window panes of the intelligent dashboard. Rather than starting with a window that says “radiology” and has an entire list of scans, the dashboard knows that he wants to see today's and yesterday's chest x-ray. Accordingly, when a doctor selects a patient, all the info that the doctor wants is pushed forward in a dashboard.

Some embodiments gather information related to user selections and preferences and analyze the data in order to automatically improve the recommendation process for other users. When users have indicated their preference for a certain dashboard (or other feature or parameter), the information related to that preference is stored for further analysis. The system then analyzes the data to determine if the recorded preferences of the users may be used to improve the recommendation processes in the future. For instance, if a number of users change a trigger value for a condition, the system may analyze those events and determine that the trigger value stored in a rules database should be updated to reflect the users' preferences. As another example, if a number of users select a lower-ranked dashboard in a list of recommended dashboards in response to an identified condition, the recommendation algorithm may be modified so that the lower-ranked dashboard becomes more likely to receive a higher ranking in the future. Thus, the system is able to continuously and automatically improve the recommendation procedures, the content of the dashboards, the rules that define conditions, etc. based on user feedback.

### II. Dashboards

A. Overview of Dashboards

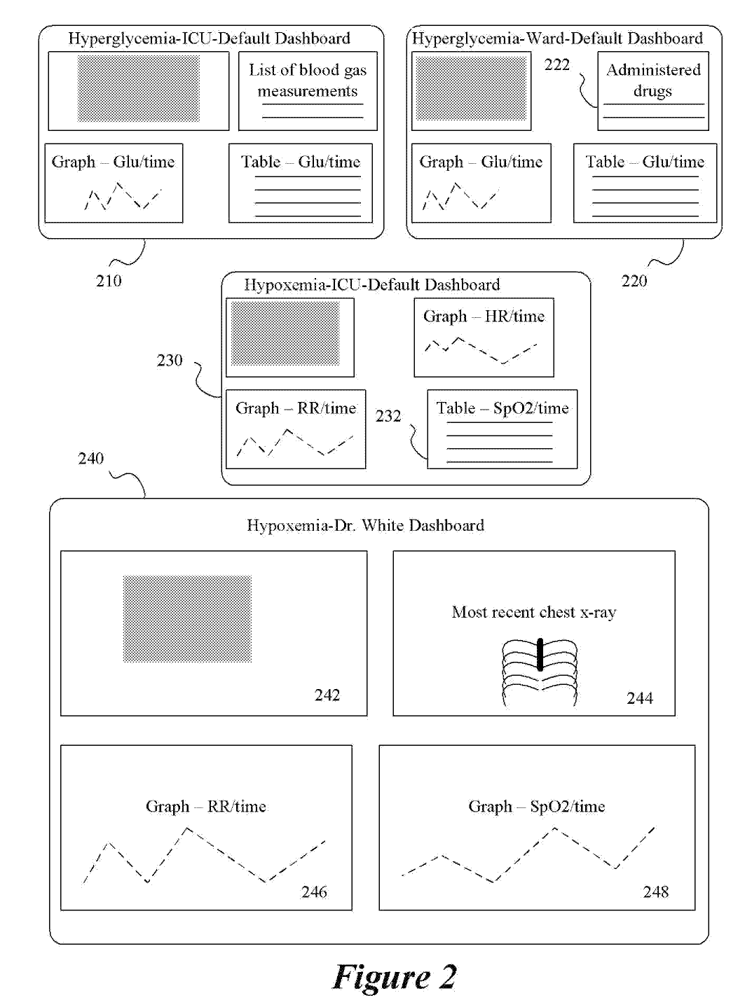

Various examples of the user interfaces (or dashboards) that could be recommended by some embodiments are illustrated in FIG. 2. FIG. 2 illustrates four different dashboards 210-240. The systems of various embodiments display dashboards on a variety of interface devices in a variety of embodiments, e.g. computer displays, PDAs, cell phones, etc. Dashboards 210 and 220 are alternate dashboards for displaying data relevant to a patient with hyperglycemia. Dashboards 230 and 240 are alternate dashboards for displaying data relevant to a patient with hypoxemia.

Each dashboard 210, 220, 230 and 240 includes multiple window panes, such as the window panes 222, 232, 242, 244, 246, and 248. The various window panes of the dashboards include information about the selected patient. For instance, the window pane 222 shows a list of drugs administered to the patient (e.g. drugs, dosages, and times), the window pane 232 shows the percentage of oxygen saturation in blood (SpO2) in a table of measurements, the window pane 244 shows an image of a patient's most recent chest x-ray, the window pane 246 shows a graph of the patient's respiratory rate over time, and the window pane 248 shows a graph of the patient's SpO2 level over time.

In some embodiments, each dashboard includes a patient list window, such as the patient list window 242 of dashboard 240. The patient list window 242 provides a list of the patients, recorded clinical data regarding each patient, computed scores generated from patient clinical data, and trends associated with the recorded data and generated scores. In some embodiments, the patient list 242 is editable, selectable, or clickable. In other embodiments, the list of patient names is not considered part of the dashboard. In some embodiments, the individual dashboards are recommended to users based on the intelligent dashboard system described in section III below. Some intelligent dashboard systems use a user interface such as the one described in subsection II.B below.

B. Clinical Information System Application User Interface

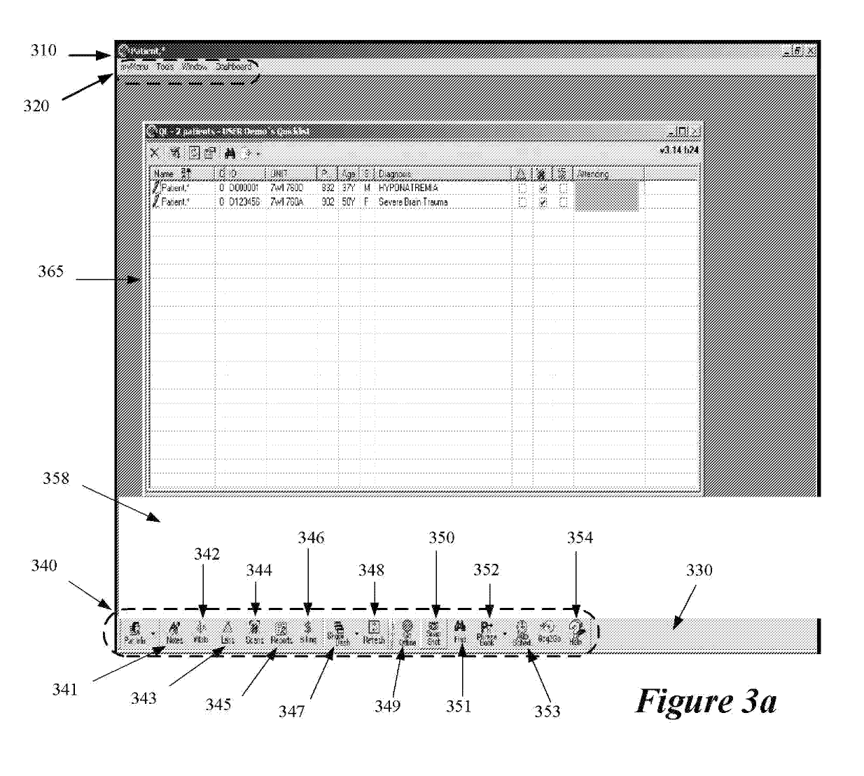

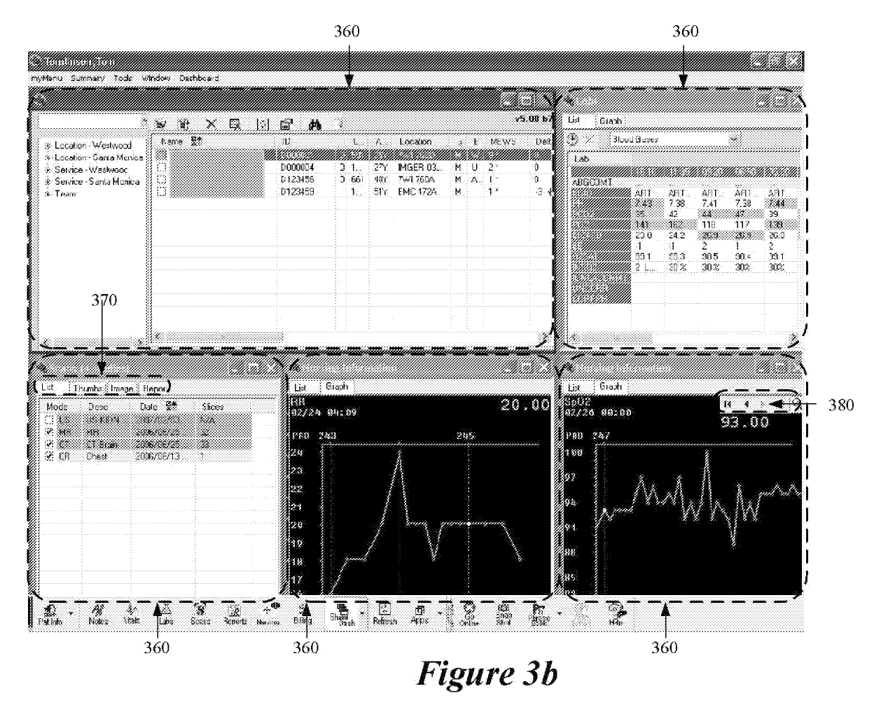

FIGS. 3a-3b illustrate a clinical information system (CIS) application user interface of some embodiments. In FIG. 3a, the user interface provides a master window 310 including a master window menu bar 320, master window toolbar 330, master window toolbar icons 340, master window viewing area 358, and patient list 365.

The master window 310 encloses the master window menu bar 320, master window toolbar 330, and master window viewing area 358. The master window menu bar 320 is located at the top of the CIS application user interface. The master window menu bar 320 lists available menu options for the CIS dashboard. When a menu bar option is selected (via a mouse click or appropriate keyboard sequence), the menu “pulls down”, revealing a list of menu items or options. These options enable the user to perform various actions within the CIS dashboard. When working offline, some menu options are not available and are grayed out.

The master window toolbar 330 includes the master window toolbar icons 340. The master window toolbar 330 appears at the bottom of the CIS application and includes toolbar icons 340 to access CIS dashboard functionality. When one of the master window toolbar icons 340 is selected, the corresponding function appears in the master window viewing area 358.

Available master window toolbar icons 340 in the master window toolbar 330 include a notes icon 341, a vital signs icon 342, a clinical labs icon 343, a scans icon 344, a reports icon 345, a billing icon 346, a show dashboard icon 347, a refresh icon 348, an applications icon (not shown), a go offline icon 349, a snap shot icon 350, a find icon 351, a phrase book icon 352, an auto schedule icon 353, and a help icon 354.

The notes icon 341 opens a new window pane that allows the user to enter clinical information into data entry forms or notes. The user can select from an existing list of notes designed by health care professionals. Examples of notes in the CIS Dashboard include nursing notes and neurosurgery encounter notes. The default for this button is called the default note and is configured via a menu item.

The vital signs 342 icon opens a new window pane that displays the patients near real-time vital sign data as monitored and communicated by the patient monitor. Available data displays include but are not limited to (a) vital sign waveform data (i.e. multi-lead ECG, invasive blood pressure ART, PAP, CVP, etc., respiration, EtCO2, SpO2, CO), (b) trend data (i.e. line trends, tabular trend data), and (c) current vital parameters updated every few seconds.

The clinical labs icon 343 opens a new window pane that displays the patient's clinical lab data results as provided by the hospitals lab information system. Data views include but are not limited to (a) present day lab results, and (b) retrospective day-by-day lab results. Lab results are color coded into groups. Abnormally high values are highlighted in purple, low values are highlighted in blue, and normal values are not highlighted. A dashboard can display lab results in tabular format and line trends.

The scans icon 344 opens a new window pane that displays the patient's radiology images as provided by the PACS. Radiology data types include but are not limited to (a) X-ray images, (b) MRI scans, (c) CT scans, (d) PET scans, (e) Dynamic Images (Cine Mode) and (f) Echo Cardiac Ultrasound. The CIS medical image application program provides a standard PAC image viewer with the ability to manipulate images (i.e. zoom, rotate, pan, contrast, inversion).

The reports icon 345 opens a new window pane that displays a list of patient specific reports. These include but are not limited to scanned text records, orders, and reports in PDF format. The billing icon 346 opens a new window pane that displays the user-defined form (e.g., a neurosurgery encounter form). The default for this button is called the charge capture form and is configured via the menu item. The show dashboard icon 347 reloads the default configuration of dashboard windows in the viewing area. The pull-down arrow displays a listing of available dashboard configurations for selection.

The refresh icon 348 allows the user to manually reload or update the patient data presented in the CIS dashboard. The applications icon (not shown) opens a new window pane that allows the user to open an external application (e.g., a drug reference database) to the CIS dashboard. The external application runs in a separate window on the user's computer.

Similarly, a web icon (not shown) opens a new window pane that allows a user to browse the web within that pane. A user can set a window pane to a specific URL and save the setting along with the rest of the dashboard. For example, a dashboard can pull up a URL in a web pane when the dashboard is loaded that is either on an intranet or the Internet and shows information useful for treatment of a heart attack (e.g. that presents protocols for such treatment). This permits a dashboard to provide conditionally specific reference material (e.g. from a digital library).

The go offline icon 349 allows the user to toggle the state of the application from online state to offline state and back without logging in and logging off. The snap shot icon 350 allows the user to capture and save the information on the screen. The user can select to capture the full screen or only the active window.

The find icon 351 allows the user to search and locate one or more patient based on user-specific criteria. The selected patients can then be added to a quick reference list. The phrase book 352 icon allows the user to enter commonly used phrases when entering patient data into notes. The phrases are created and saved by the user and available in all text forms involving editing.

The auto schedule 353 icon allows the user to set automatic patient data downloads to the computer or handheld device activated at a user-defined schedule. The help icon 354 displays online help, which provides assistance in the use of the application.

Toolbar buttons 340 are different in different embodiments. Depending upon the configuration of a CIS, some of the application buttons may not be loaded on the interface. In some embodiments, some menu options are not available and are grayed out when a user is using the interface offline.

The master window viewing area 358 is the main area of the CIS dashboard that displays a patient list 365 including patient information from various other hospital systems. In some embodiments, the master window viewing area 358 includes smaller windows called window panes. For instance, in FIG. 3b, there are multiple window panes 360 displayed in the viewing area 358. Each of the window panes 360 can be arranged, resized, or managed by the user. In some embodiments, a user can click within the pane to modify data, sort data, copy, paste, or drag and drop data. The set of window panes 360 collectively comprise a CIS dashboard of the illustrated embodiment.

The window panes 360 are displayed in the master window viewing area of the CIS dashboard and present patient information collected and integrated from a variety of clinical systems. Each of the window panes 360 includes a set of selectable tabs 370, additional window pane toolbars, and controls 380.

The clinical data content of a window pane can be called a window pane “view”. Some window panes are capable of displaying more than one different view. In some embodiments, selectable tabs 370 affect what view a window pane displays. For example, the set of selectable tabs 370 at the top of a window pane allow a user to select different views presenting different clinical data. A single view can have additional window pane toolbars and controls 380 to sort and navigate the clinical data presented. In some embodiments, such a CIS system includes an intelligent dashboard system for providing suggestions of dashboards to a user.

### III. Intelligent Dashboard System

A. Overview of Intelligent Dashboard System

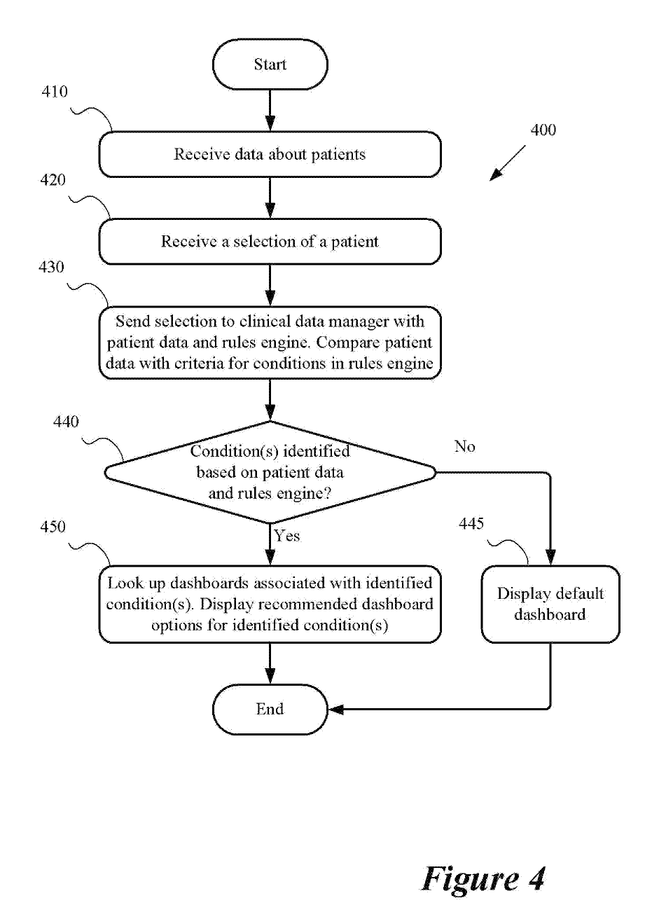

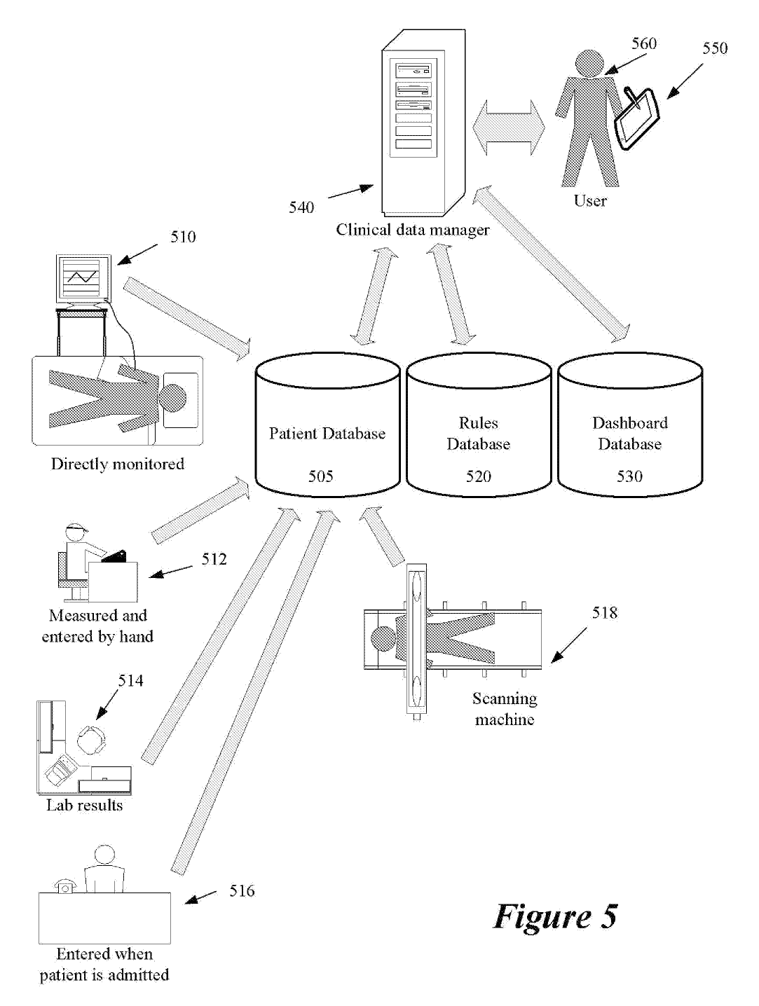

FIG. 4 illustrates an intelligent dashboard process 400 for identifying conditions and, based on the conditions, recommending dashboards to display patient statistics. The operations of FIG. 4 will be described in conjunction with FIG. 5, which illustrates some components of the system in some embodiments. One of ordinary skill in the art will realize that other embodiments may use different components than those illustrated in FIG. 5 while still remaining within the scope of the invention.

In operation 410, the process 400 receives patient data. As FIG. 5 shows, operation 410 can receive data from several different sources 510-518 (further described in subsection III.B below) that feed data into a patient database 505. The process receives, at 420 a selection of a patient from display unit 550 by user 560.

Operation 430 sends the selection to a clinical data manager 540 with access to the patient data, a rules database 520, and a dashboard database 530. Operation 440 uses the clinical data manager 540 to analyze the patient data and compare various statistics about the patient to statistics that identify various conditions (e.g. medical conditions) in the rules database 520. In some embodiments, operation 440 can identify non-medical conditions. For example, the operation 440 could identify the condition that the patient's primary physician is a neurologist.

If the patient data does not match any of the conditions identified in the rules database 520, then operation 440 does not recommend a dashboard associated with an identified condition, a default dashboard is displayed by operation 445, and process 400 ends. In some embodiments, when no condition is identified, the process 400 recommends default dashboards and the user selects one, rather than the process 445 automatically displaying a default dashboard.

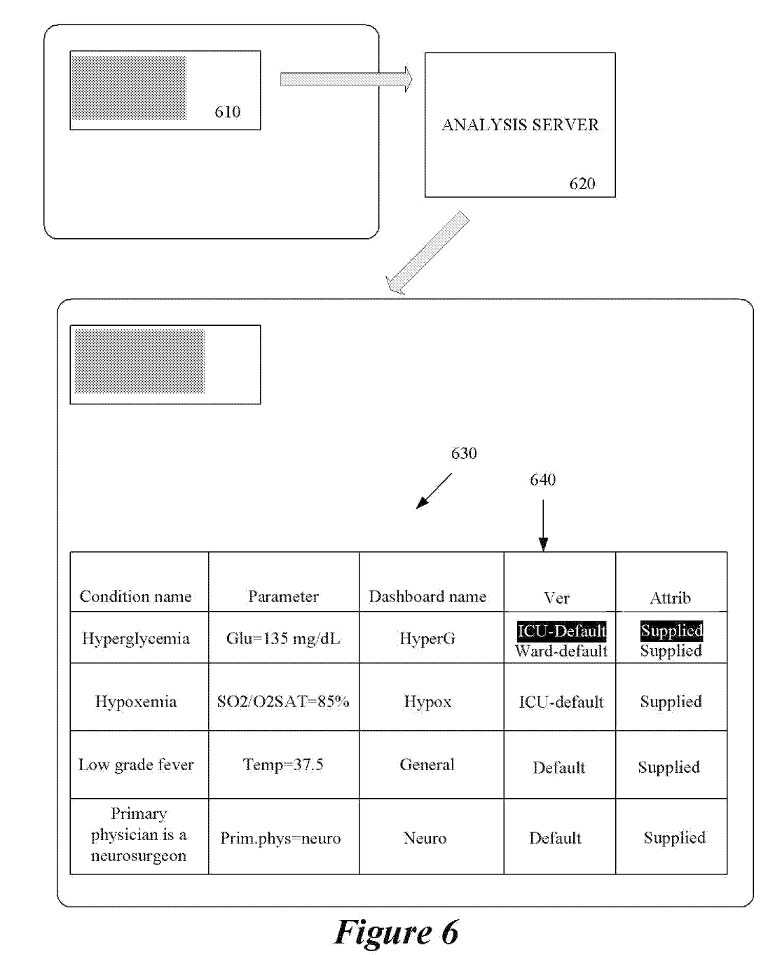

If operation 440 identifies at least one condition, then operation 450 looks up the dashboards associated with the identified condition(s) in the dashboard database 530 and presents them to the user 560 as options. A graphical user interface of some embodiments for performing operation 450 is illustrated in FIG. 6. After a patient's name is selected from list 610 and is passed to analysis server 620, and the analysis server 620 identifies conditions of the patient (as previously described in operations 420-440), a list of recommended dashboards 630 is displayed.

The list 630 of some embodiments includes the names of the conditions that the system has identified for the patient. For each of these condition names, the list shows the variable or variables that caused the system to identify the condition, along with the value of those variables exhibited by the patient. For example, hyperglycemia is identified by the glucose level and the patient's glucose level is 135 mg/dL. The list 630 also shows a general dashboard name and lists available versions of the dashboard 640. The list shows an attribution for each of the versions. In list 630, all of these attributions are “supplied” to indicate that the recommended dashboards are the dashboards supplied by the company that produced the intelligent dashboard application. Examples of other attributions are described in subsection IV.C below. In some embodiments, each version of the dashboard has a different name and the system identifies all the available names rather than general names and versions as shown in FIG. 6.

One of ordinary skill in the art will realize that many of the specific features described above can be provided in different ways while remaining within the scope of the invention. For example, in some embodiments, two or more of the described databases may be combined into one database (e.g. a combined rules and dashboard or rules, patient data, and dashboard database). In some embodiments, a selection of an appropriate dashboard for a given condition may be made automatically for some or all users, rather than presenting the user with options, particularly if only one condition is identified and only one dashboard exists for that condition.

In some embodiments, the recommended list is a pop-up, superimposed on the dashboard. In other embodiments, the recommended list is an ordinary pane in the dashboard. In some embodiments, a list of identified conditions is provided; the user selects a condition; and only then are the available dashboards for the selected condition supplied. In some embodiments, a default dashboard is supplied while the system is waiting for the user to select a dashboard from a list. In some embodiments, the default dashboard is selected if the user does not make a selection in some pre-set amount of time.

In some embodiments, the recommendation list ranks conditions by the severity of the conditions, e.g., how abnormal the conditions are. That is, what the difference is in percentage between the values that triggered that condition and the upper or lower level of the condition threshold. For example, if the glucose is 300% above normal and the hypoxic percentage is only 20% off, then the recommendation list might list them in that order. In some embodiments, the recommendation list ranks conditions by the rate at which the severity is increasing. Further examples of determination of severity can be found in sub-section IV.B below.

B. Patient Data Sources

As mentioned above, in some embodiments illustrated in FIG. 5, the patient database 505 receives data from a variety of sources. Direct monitoring sources 510 continuously keep track of some bit of information about the patient, for example heart-rate monitors, electro-cardiographs, intracranial pressure monitors, etc. Some sources 512 are measured and entered into a computer manually, for example, blood pressure taken with an analog pressure cuff, weight, or direct observations such as “hives”, “jaundice”, etc. Lab results 514 can either be entered by hand (e.g. “sickle cell trait”) or in some cases directly supplied to the system by the machines measuring the relative quantities (e.g. blood glucose 130 mg/dL). Some data in the database may be entered when the patient is admitted, some of the information from such sources may be non-medical, such as the name or ID number of the patient, the name of the patient's doctor, or insurance company, a number used for a system for tracking patient's within the hospital such as bar coded bracelets etc. Data such as images from medical scanners 518 can also be entered into the patient database. For example, digitized images of x-rays, CT scans, or MRIs.

C. Software Architecture

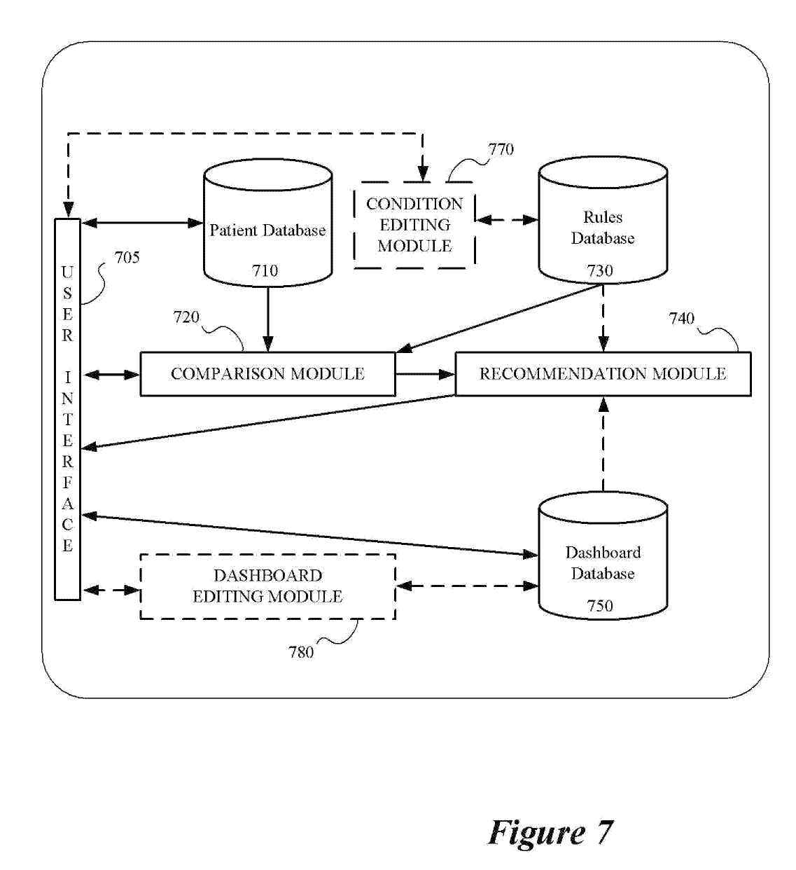

FIG. 7 illustrates a software block diagram of some embodiments for implementing process 400. A user interface 705 accesses patient database 710 to get a list of patient names and/or patient identification numbers. The user interface 705 is used to select a patient from the list of patients. The user interface 705 activates a comparison module 720 (sometimes called a “rules engine”) that accesses data from the patient database 710 and a rules database 730. The comparison module 720 compares the data from the patient database 710 against the rules in the rules database 730 to determine whether the patient has any conditions identified in the rules database 730. In some embodiments, user information (e.g. ID, location, job) are provided by the user interface 705 for use in determining conditions. In other embodiments, user information is stored in the patient database 710. In other embodiments, some other source provides user information that is relevant to determining conditions.

If the patient does have any conditions identified in the rules database 730, the comparison module activates a recommendations module 740. The recommendations module 740 generates a list of the condition(s) of the patient along with a list of dashboards associated with the condition(s) and sends the lists to the interface module 705. In some embodiments, the recommendations module 740 receives the patient's condition(s) from the comparison module 720, and retrieves a list of dashboards associated with each condition from the rules database 730. In other embodiments, the recommendation module 740 receives the list of conditions and the lists of associated dashboards from the comparison module 720. In still other embodiments, the recommendation module 740 retrieves the lists of dashboards associated with each condition from a dashboard database 750.

In addition to identifying conditions from a database of rules and conditions and recommending dashboards from a database of dashboards, some embodiments allow users to edit the rules and conditions and/or dashboards in their respective databases. Accordingly, some embodiments include an editing module 770 that can be accessed by the user interface 705 to edit the rules and conditions in the rules database 730, examples of such embodiments are described in subsection IV.A below. Also, some embodiments include an editing module 780 for allowing users to edit the dashboards, examples of such embodiments are described in subsection IV.C below. Some embodiments gather the information related to these user edits in order to automatically improve the rules and dashboards that are used in the future. These system learning aspects are described in Section VI below.

### IV. Editing the Knowledge Base

A. Process for Editing the Rules

As described above, the system of some embodiments has a rules database that identifies conditions. Such a rules database can include any number of saved rules/conditions, such as “if glucose>130 mg/dL then patient has hyperglycemia”. The rules (e.g. “if glucose>130 mg/dL”) tie certain values of variables describing the patient's characteristics to identified conditions (e.g. hyperglycemia) in the database. In some embodiments, a user or organization can develop a rules database from scratch, add new conditions to an existing database, or amend the rules identifying existing conditions as needed.

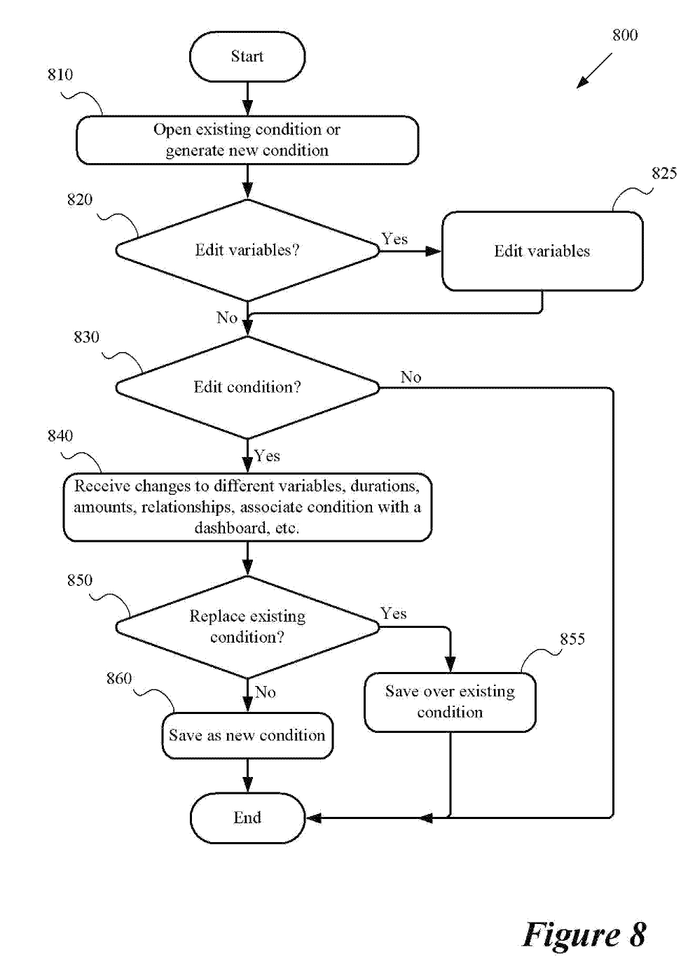

In some embodiments, users are able to edit the conditions that the comparison module (or rules engine) recognizes. The rules editing module 770 uses a rules editing process such as the one illustrated in FIG. 8 to teach the rules engine to recognize certain combinations of data as indicating particular conditions. The process 800 may use a rules editor, such as the one described in subsection IV.B below.

Operation 810 starts the editing by opening an existing condition for editing or generating a new (e.g. blank) condition for editing. In some embodiments, the process includes an option 820 to edit variables in operation 830. Editing variables can include adding new variables (e.g. when a test is developed for a previously unknown or unmeasured substance in the blood) and changing the source from which the system will accept values of existing variables (e.g. when a hospital changes from using analog pressure measurements entered by hand to digital pressure measurements uploaded automatically). In some embodiments, a user can edit variables without first opening a condition for editing.

In some embodiments, the editing of the variables includes editing normalization parameters associated with the variables. For instance, when changing to a new source of data, users may want to enter scaling, threshold, and/or other parameters that will control how the data is retrieved and stored. Normalization will be described in more detail in Section V below.

Once editing of the variables (if any) is concluded, the process has an option 830 to edit conditions. If the user does not want to edit the condition, then the process 800 terminates. If the user does want to edit the condition, then operation 840 receives changes to the variables, durations, amounts, and/or relationships that identify the condition, such changes are further described in subsection IV.B below.

After a condition has been edited, the process 800 has an option 850 for replacing an existing condition by saving over it at 855 (e.g. replacing the definition of hyperglycemia, by changing the threshold from 130 mg/dL to 120 mg/dL) or saving a new condition at 860 (e.g. adding a newly developed aggregate diagnostic score such as Multi Automated Severity Scoring to the previously existing conditions in the database).

One of ordinary skill in the art will realize that while the above description describes editing conditions discretely, some embodiments may provide a user with an entire list of conditions and their identifying rules and allowing changes to be made to any condition in the list before resaving the list.

B. Rules Editor

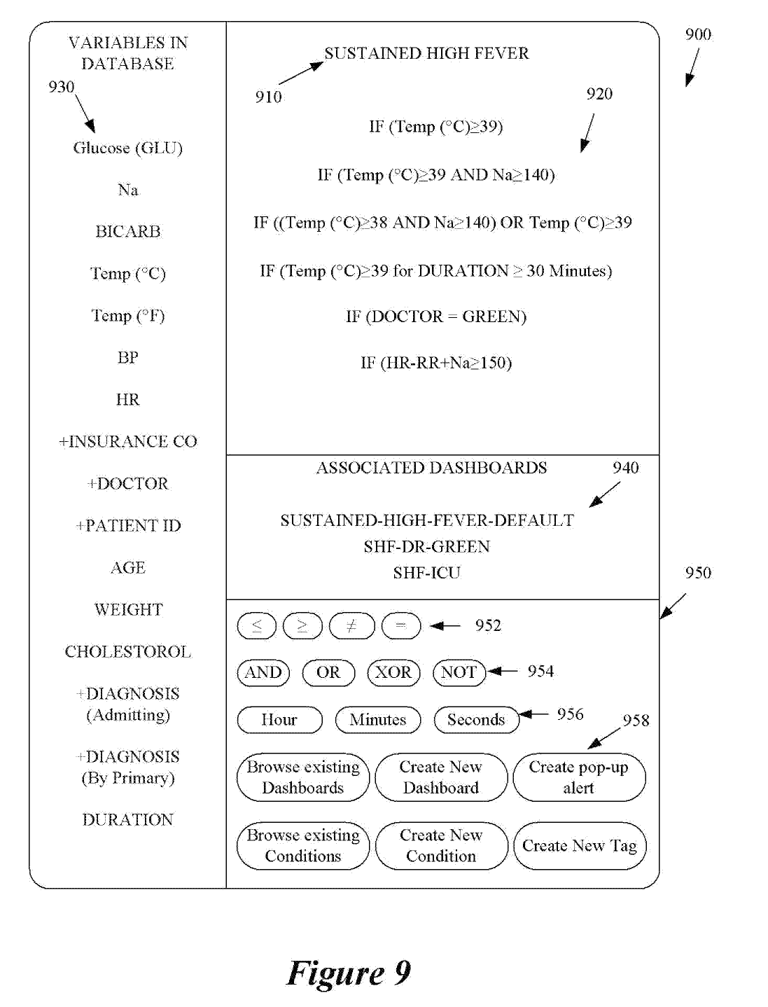

FIG. 9 illustrates a rules editor 900 of some embodiments. The editor includes a rules area that lists the condition 910 being edited and several possible rules 920 that define that condition. The editor includes a variables list 930 that lists the variables available for using to generate rules. The editor 900 includes an area 940 that lists the associated dashboards for the condition. The editor includes a set of buttons 950 for editing expressions in the rules 920.

In some embodiments, multiple sets of rules may indicate a single condition, however the multiple illustrated rules 920 are offered as multiple examples of possible rules. The rules 920 can include relational conditions (e.g. greater than, less than, greater than or equal to, etc.), such as “temperature greater than or equal to thirty-nine degrees”. They can also include multiple conditions, such as “temperature greater than or equal to thirty-nine degrees AND sodium greater than or equal to 140 mmol/L”. The rules can also include complex Boolean conditions, such as “(temperature greater than or equal to thirty-eight AND sodium greater than or equal to 140 mmol/L) OR temperature greater than or equal to thirty-nine”. The rules can include a duration associated with other variables, such as “temperature greater than or equal to thirty-nine for more than thirty minutes”. The rules can even include mathematical formulae, such as “heart rate minus respiratory rate plus sodium is greater than or equal to 150” (HR−RR+Na≧150). In this example, the heart rate, respiratory rate, and sodium value may have first been converted to purely numerical (i.e., unitless) values before the calculation is performed by multiplying (or dividing) each value by the appropriate units. The rules can also be as simple as “Diagnosis (admitting)=Heart attack”.

The variable list 930 could include any variables deemed necessary or relevant to determining conditions. In some embodiments, the variables relate to medical conditions only, however, in other embodiments, the variables could include such information as the patient's name, the patient's doctor, the type of doctor (e.g. neurologist), the patient's insurance company, the patient's ID number, whether the patient is scheduled for surgery, or discharge, or any other variables that whatever user has editing privileges for the list would enter into the list.

For example, individual doctors may have dashboards that they prefer to be used whenever one of their patients is examined. Names of doctors in the illustrated embodiment are preset into the system (as indicated by the “plus” sign next to the variable). Accordingly, when that variable is selected, the user can select a doctor from an available list (or add a new doctor to the list). In other embodiments, the doctor's name may be entered by hand, rather than from a list. Similarly, a particular patient may have some set of conditions that would be better monitored by a custom designed dashboard, rather than a general dashboard applicable to multiple patients. Accordingly, in some embodiments, the condition “This is patient Fred Smith” (or a unique patient ID number to avoid conflating same-name patients) may be defined with the rule “If patient=Fred Smith” and associated with a dashboard “FRED-SMITH-DASHBOARD”.

The variables can also include variables that do not relate directly to the patient. For example, the variables could be used to create patient conditions that depend on factors about the user who will be presented with the dashboards. For example, a “user-position” variable could check for values such as “nurse” or “doctor”. Such a variable could also check for more specific values such as “cardiothoracic surgeon” or “podiatrist”. Such variables could be used in rules to provide different dashboards for different personnel. In some embodiments, a variable for the location of the user could be used to identify a condition. For example, if the user is in an operating room, in an ICU or in an office.

By creating rules that combine various variables, a user can define very specific patient conditions. For example, a user can define a patient condition that only occurs when a patient has glucose above 135, the patient is in the cardiac unit, the patient's primary physician is a immunologist, the user trying to view data on the patient is an internist, the patient was diagnosed as having iron poisoning when admitted and the patient is scheduled for surgery in more than 48 hours but less than 72.

The list of dashboards in area 940 shows which dashboards are associated with the particular condition being edited, and thus, which dashboards will be offered as suggested dashboards when a patient is identified with variable values matching the rules for that condition. In some embodiments, the dashboards may have some identifying feature that indicates what classes of users or what individual users are authorized to use them. In some embodiments, the rules editor 900 can set permissions for the listed dashboards. More information on permissions can be found in subsection IV.C below.

The set of buttons 950 includes buttons 952 for entering a relationship, such as “greater than or equal to”. Buttons 954 allow a user to enter a Boolean condition (e.g. “AND” or “OR”). Buttons 956 allow users to set whether the duration for a condition should be measured in seconds, minutes, or hours. Buttons 958 allow a user to associate the condition being edited with an existing dashboard, create a new dashboard to associate with the condition, create an alert to pop up if the condition is detected, browse existing conditions, create a new condition or create a new variable as described in subsection IV.A above.

One of ordinary skill in the art will realize that the rules editor described above is merely an example and that rules editors with more, fewer, or different features could be used without departing from the scope of the present invention. For example, any of the associated buttons could be substituted with or used alternatively with hot-keys for activating the same functions.

In some alternate embodiments, conditions may include within their rules a gauge of the severity of the condition. This allows the experts who program the system to determine what conditions are most serious. This is useful when contrasting conditions for which a small deviation from the normal range is more significant than a large deviation in other conditions. For example, a 10% increase in body temperature over the normal 37 degrees Celsius (i.e. 40.7 degrees Celsius, or 105.3 degrees Fahrenheit) is a far more severe condition than a 50% increase in cholesterol levels. A user can assign a base line severity to some conditions, such as a high severity to conditions that identify an imminent heart attack. A user can also assign a “severity” to non-medical conditions. For instance, a particular doctor may have a preferred dashboard that will be the default for him unless an extremely severe medical condition is identified.

C. Process for Editing Dashboards

As described above, the system of some embodiments has a dashboard database that provides dashboards for displaying patient data. Such a dashboards database can store any number of dashboards associated with any number of different conditions. Each dashboard displays information from the patient database in a way that is designed to be relevant to the particular condition with which the dashboard is associated.

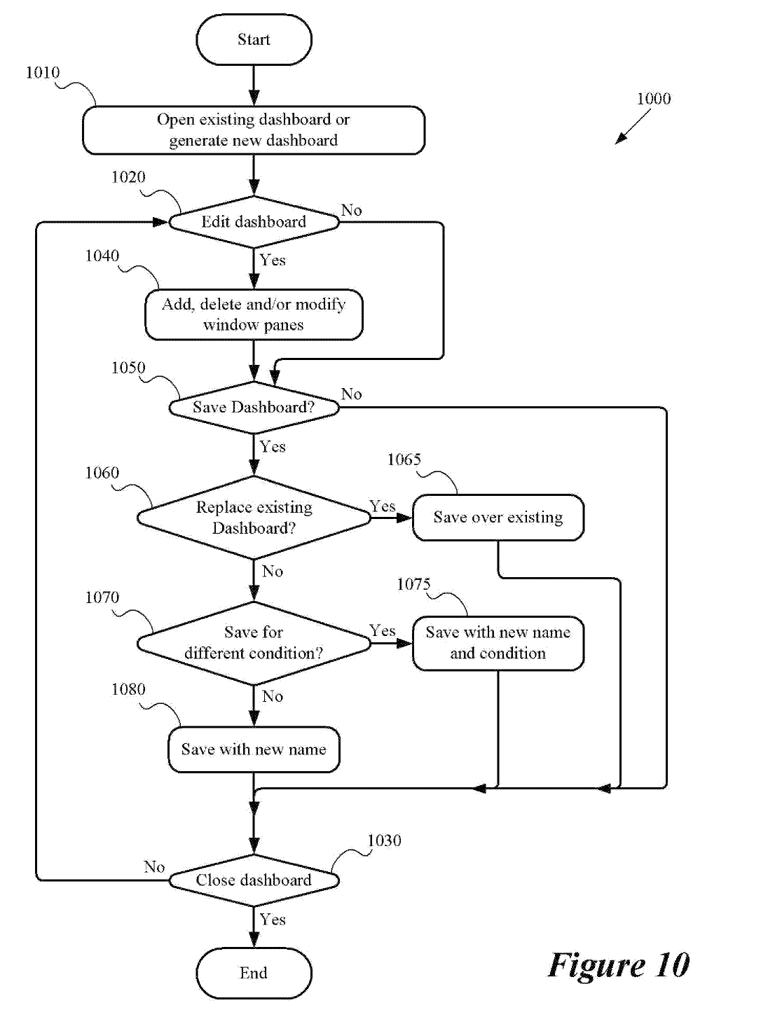

In some embodiments, users can modify dashboards and save their modifications so that when the condition associated with the dashboard is identified in another patient, the recommendation list includes a dashboard with the saved modifications, either instead of, or as well as the previous version. FIG. 10 illustrates a process 1000 of some embodiments for editing and saving a dashboard. The process 1000 starts with operation 1010, in which the process 1000 opens an existing dashboard or generates a new dashboard.

In some embodiments, opening a dashboard for editing is identical to opening a dashboard for use. This is reflected in option 1020 in which the system offers the user a choice of whether to edit the dashboard or not. In some embodiments, this is not offered as a direct confrontational choice, but instead, editing is an option as long as the dashboard is open. This is reflected in the loop between the editing option 1020 and the close dashboard option 1030 (after many intervening options and/or operations).

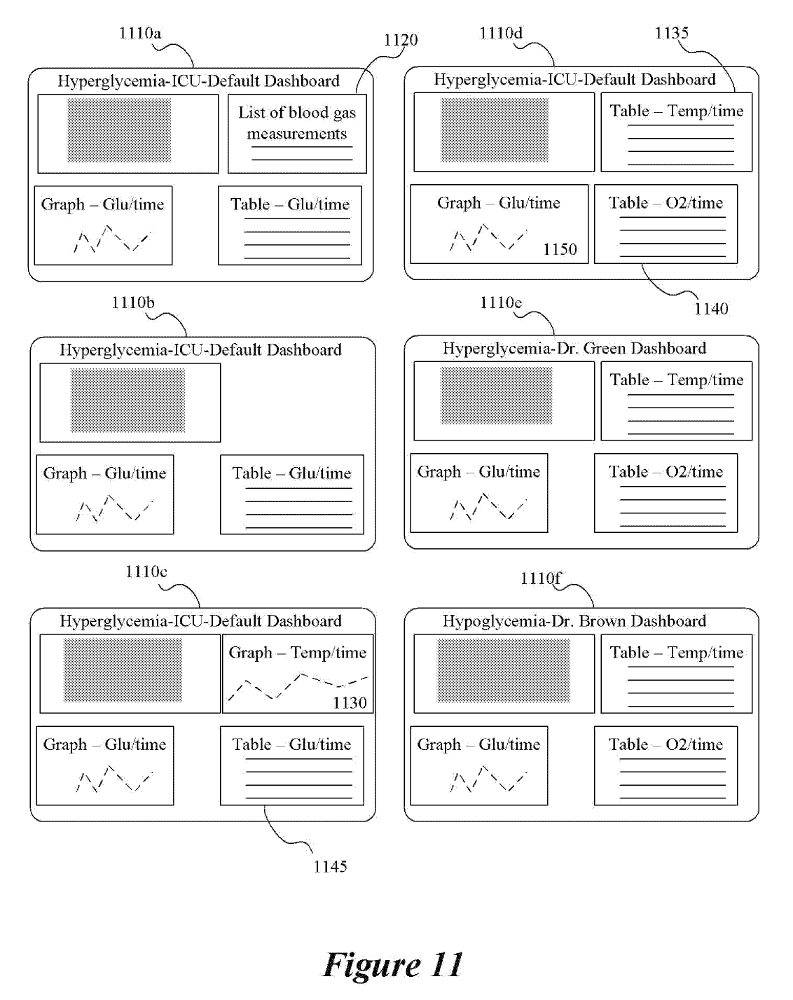

If the process receives commands from the user to edit the dashboard, then operation 1040 edits the dashboard according to the user's commands. Some modifications of dashboards are illustrated in the sequential dashboards of FIG. 11.

Dashboards 1110a-1110d represent different stages of editing a dashboard that illustrate the editing options of deleting, adding, and modifying window panes, while dashboards 1110e and 1110f represent various saving options to be explained later. Dashboard 1110a shows a default dashboard including window pane 1120 that displays a list of blood gas measurements. In Dashboard 1110b the process 1040 has deleted window pane 1120 at the command of the user. In Dashboard 1110c, the operation 1040 has added a new window pane 1130 that displays a graph of temperature versus time. In Dashboard 1110d, the operation 1040 has modified pane 1130 so that the modified pane 1135 shows temperature versus time as a table, rather than as a graph. Dashboard 1110d includes window pane 1140 that shows O2 versus time rather than glucose versus time like the corresponding window pane 1145 in dashboard 1110c. Finally, in dashboard 1110d, the process 1040 has expanded the size of window pane 1150.

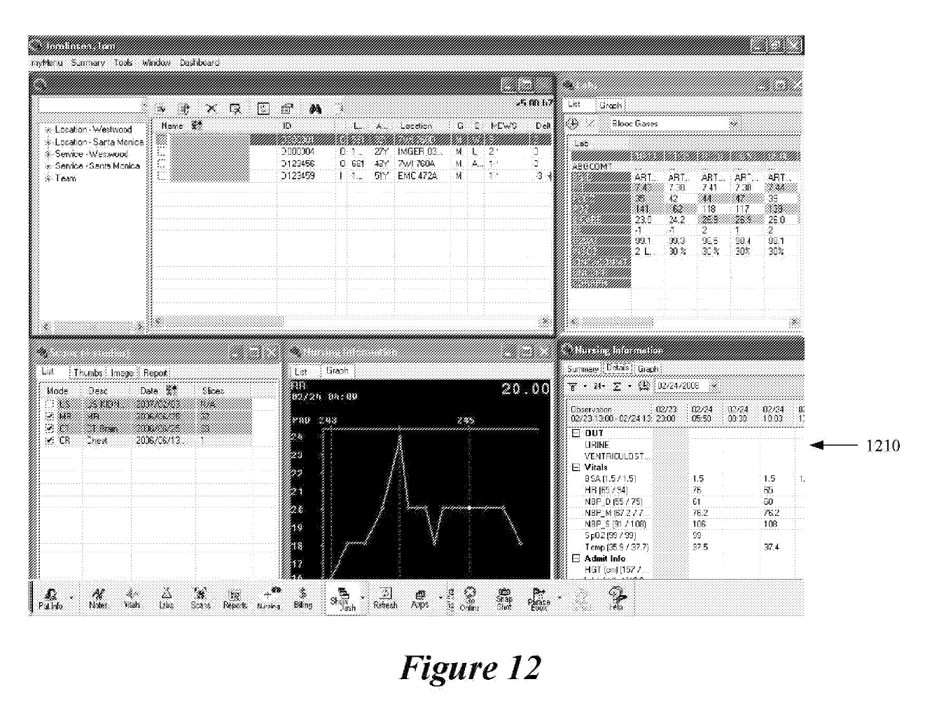

FIG. 12 illustrates an example of a modified dashboard from an exemplary application. The dashboard of window panes 360 from FIG. 3b above is the default dashboard. A user has modified the dashboard to view the SpO2 data in a table 1210 with other vital statistics instead of as a graph.

Once the process 1000 has edited the dashboard in operation 1040, the process 1000 provides the user with the option to save the edited dashboard in operation 1050. If the user chooses not to save, then the process 1000 resumes the loop from 1020 to 1030. This allows the user to change a dashboard temporarily without saving a dashboard that the user wants to use but not save. If the user chooses to save, then the process 1000 offers option 1060, to replace the existing dashboard or not. If the user chooses to replace an existing dashboard, then operation 1065 saves the edited dashboard over the existing dashboard.

The process 1000 also offers the option 1070 to associate the dashboard with a different condition upon saving. If the user chooses option 1070, then the operation 1075 saves the dashboard under its new name for its new condition. FIG. 11 illustrates this in dashboard 1110f in which the dashboard has been associated with hypoglycemia rather than hyperglycemia. This option is useful when several similar or related conditions exist which call for similar dashboards.

If the process 1000 is saving, is not replacing the existing dashboard, and is not associating the dashboard with a new condition then by process of elimination, the only option left is saving the dashboard for the existing condition, but under a new name, as shown in dashboard 1110e. After all of the save options described above, the process 1000 proceeds to the close dashboard option 1030 and either closes the dashboard or returns to the options loop, starting with edit dashboard option 1120.

One of ordinary skill in the art will realize that the illustrated embodiment of data editing is only one possible embodiment of dashboard editing. Other embodiments are described in U.S. patent application entitled “Drill Down Clinical Information Dashboard,” having Ser. No. 12/036,281, filed on Feb. 24, 2008. Said application is incorporated herein by reference. Even beyond that application, other embodiments are possible within the scope of the present invention.

D. Security and Permissions

The previous parts of section IV describe the processes of editing conditions and dashboards. In order to keep the descriptions as simple as possible, the sections simply referred to “users” editing these items. However, in some embodiments, not all users have equal permissions to modify dashboards and conditions. In some instances, individuals may have private dashboards that others are not allowed to access. In others instances, in order to ensure that the default version is not lost, however users modify copies of it, the default version of a dashboard may be accessible to all, but can only be overwritten by a system administrator.

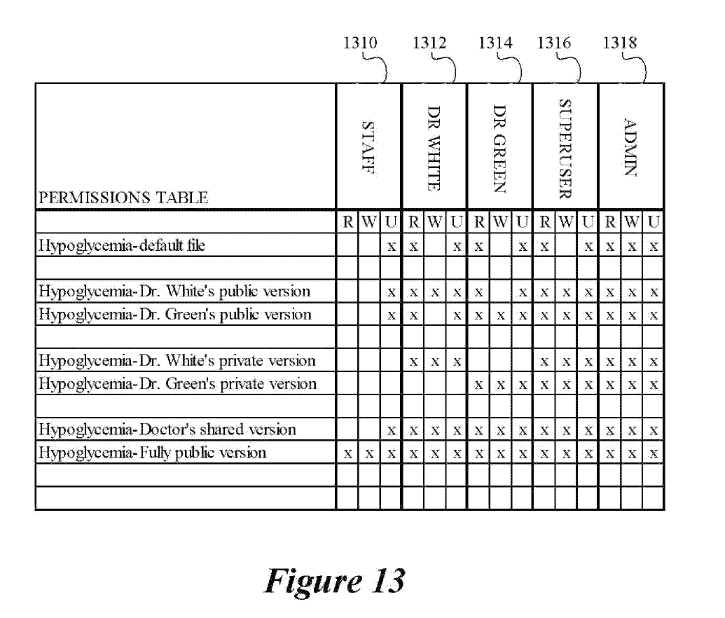

FIG. 13 illustrates a table of permissions of some embodiments for various dashboard files. The table identifies five users in four classes: a staff member 1310, doctors 1312 and 1314, a superuser 1316, and a system administrator 1318. Each of these users has different permissions for different files. If there is an “x” in the “W” column for a particular file, for a particular user, then the user has permission to write (e.g. overwrite or replace) the file. If there is an “x” in the “R” column for a particular file, for a particular user, then the user has permission to read (e.g. copy) the file. Reading a file can be useful, even if the user doesn't also have permission to write to the file. For example after reading a file, a user would be able to edit it and possibly save it under another name if they have write permission in any accessible file location. Finally, the last level of access is indicated by an “x” in the “U” column for a particular file, for a particular user. This indicates that the user has permission to use the file as a dashboard, even though they can't save it. In some embodiments, permission to use implies that the system allows the user to edit dashboards for one-time use of the modified dashboard, but not the ability to save the modified dashboard. The following description explains various levels of permission in the illustrated embodiment by explaining the typical permissions available at successively higher levels of access.

In the illustrated embodiment, the staff member 1310 has very low access rights. Other than a fully public file that is fully accessible to everyone, the staff member 1310 is not permitted by the system to read or write any file. The staff member 1310 can use only those dashboards designated for public use. This limited access is useful for staff members whose duties require them to monitor patients but who do not need to make their own dashboards.

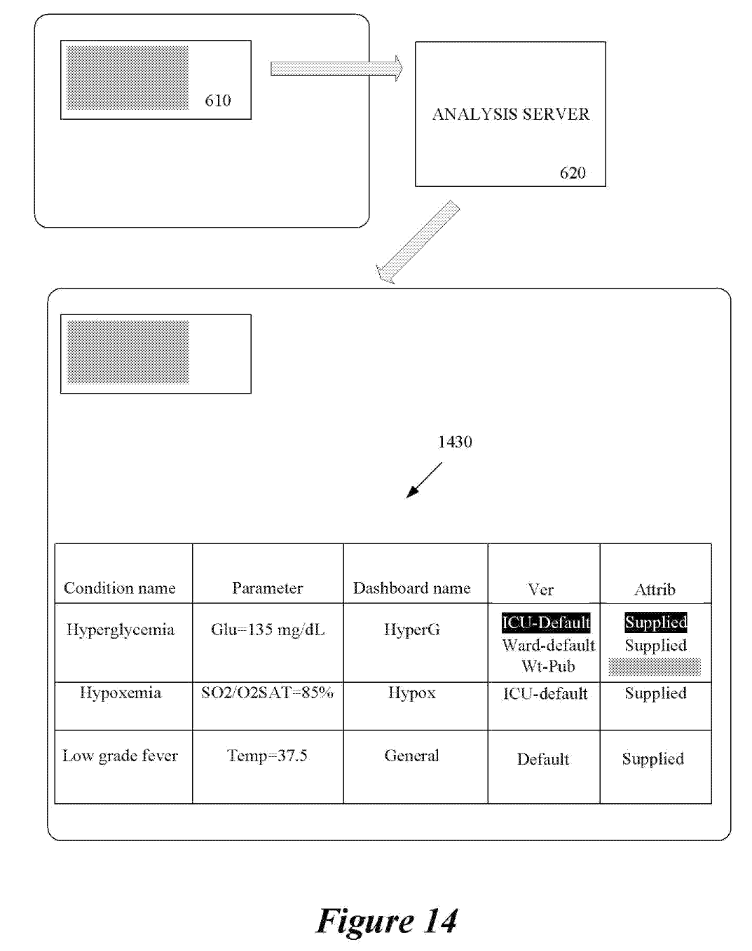

The doctors 1312 and 1314 can have private or public dashboards. Their public dashboards can be used by anyone, read by other doctors, and written by themselves and by the superuser 1316 and system administrator 1318. Having public versions available allows a doctor to make his own dashboard, let others benefit from the creation, but not have to worry about others deliberately or accidentally tampering with his work. FIG. 14 illustrates an example of a dashboard recommendation list 1430 with a doctor's public dashboard available for use and attributed to Dr. White.

The doctors' private dashboards are available only to themselves, superusers, and system administrators. This is useful as doctors may use dashboards privately that would confuse others. This also allows doctors to experiment with new dashboards without risking other users selecting an unfinished dashboard. Doctors can read the default dashboard but can't write to it. This prevents the default dashboard from being altered repeatedly by doctors with differing opinions of what should be in the default file.

A superuser 1316 is a user with higher than normal permissions, for example, a department head may need to access dashboards from any doctor in his department. In this embodiment, the higher than normal permission includes full access to doctors' public and private dashboards, but not permission to overwrite the default dashboard.

The system administrator 1318 of this embodiment has full access to all dashboards. This is useful because at least one user of the system is able to access everything and fix errors that may occur. For example, a system administrator 1318 can edit the default dashboards that need to be updated to reflect changes to the databases, new technology, or other reasons.

Appropriate entities can set these permissions. For example, the system administrator 1318 or a superuser 1316 can take particular dashboards out of use by removing all use permissions. In some embodiments, doctors determine who can use their versions, in others only superusers can allow anyone to use someone else's dashboards. This can be useful as a clutter prevention measure so that the staff isn't presented with 47 recommended versions from 47 different doctors. In some embodiments, only the creator of a dashboard can set permissions for it, even superusers or system administrators are unable to change it without permission. In some embodiments, the creator of a dashboard is the only one who can access it and there is no way within the normal functions of the system to give any other user access to it.

Similar restrictions on permissions apply to editing of conditions in some embodiments. In fact, there are good reasons to restrict permission to edit conditions more strictly than permission to edit dashboards. The rules database of some embodiments provides identification of patient conditions as well as recommending dashboards. If a dashboard does not include information pertinent to an identified condition, a skilled medical practitioner is likely to recognize this and react accordingly, either by editing the dashboard or by switching to an alternate dashboard. However, if a condition is incorrect, a medical problem that could be easily treated may go unnoticed until it is too late. Accordingly, to reduce the risk of accidents, the rules engine of some embodiments is editable only by superusers, or even editable only by system administrators.

### V. Normalization

Some embodiments provide a normalization process that is used to format data provided by different external reporting systems for use in generating and/or triggering dashboards within the existing clinical data manager system. Normalization may include scaling the data, filling in missing values, removing data outside reporting thresholds, and/or other data manipulations to make the data useable by the clinical data manager. Subsection V.A below describes the software architecture of some embodiments that includes a normalization module. Subsection V.B below describes a process of normalizing data from an external reporting system.

A. Software Architecture

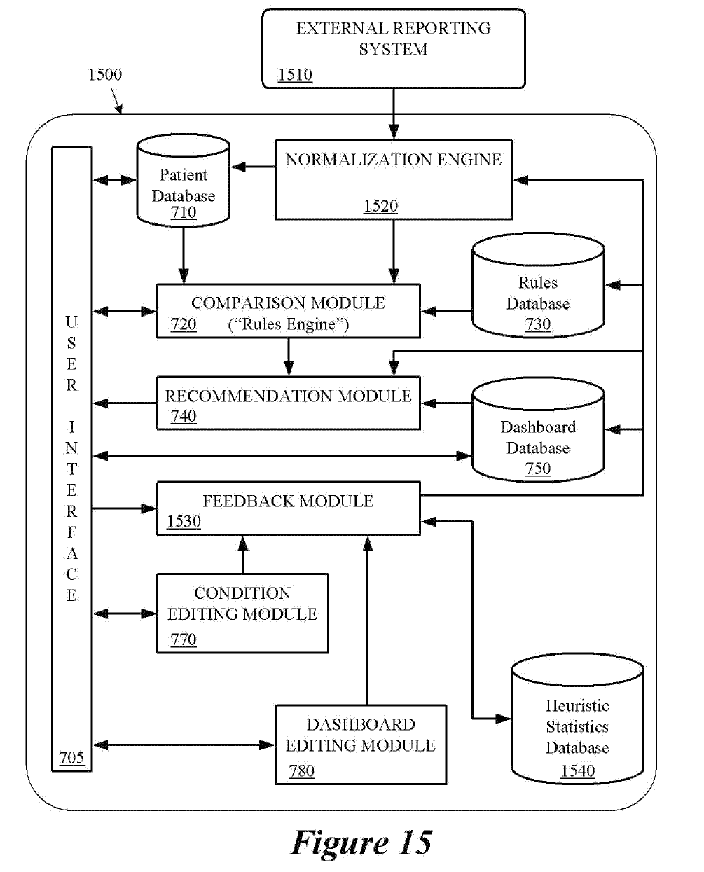

In some embodiments, the processes described above are implemented as software running on a particular machine, such as a computer or a handheld device, or stored in a computer readable medium. FIG. 15 conceptually illustrates the software architecture of an application 1500 of some embodiments for presenting clinical data such as those described in the preceding sections. In some embodiments, the application is a stand-alone application or is integrated into another application (for instance, application 1500 might be a portion of a data reporting system), while in other embodiments the application might be implemented within an operating system. Furthermore, in some embodiments, the application is provided as part of a server-based (e.g., web-based) solution. In some such embodiments, the application is provided via a thin client. That is, the application runs on a server while a user interacts with the application via a separate client machine remote from the server (e.g., via a browser on the client machine). In other such embodiments, the application is provided via a thick client. That is, the application is distributed from the server to the client machine and runs on the client machine.

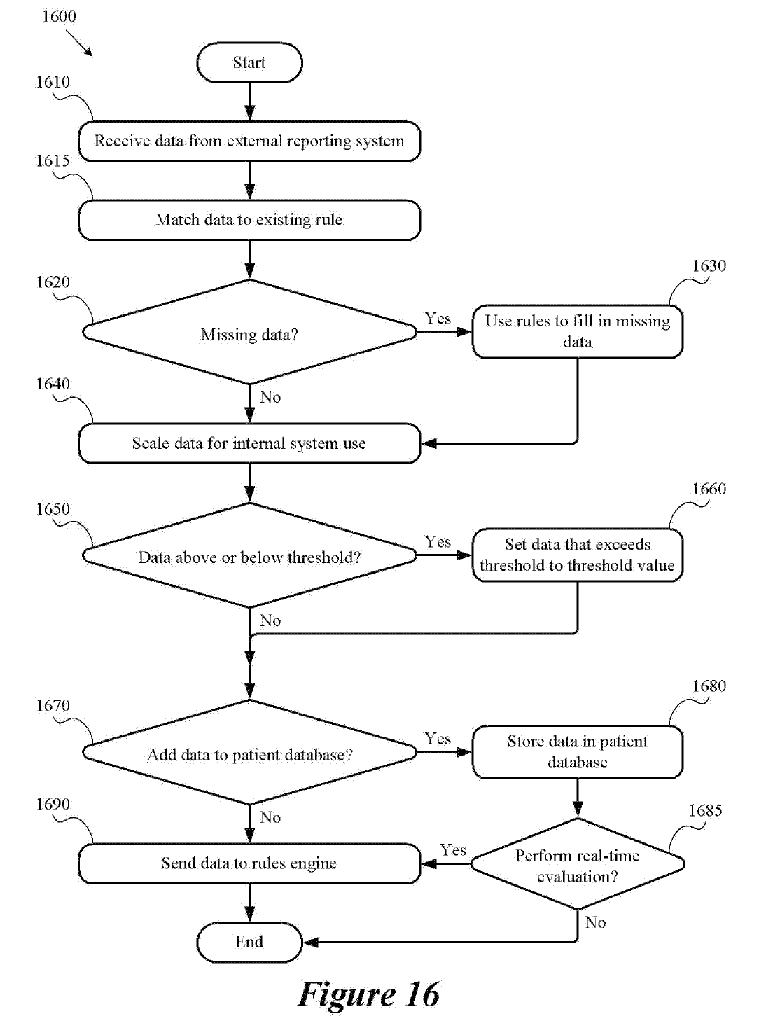

FIG. 15 illustrates a software block diagram of the clinical data manager 1500 of some embodiments that implements a normalization process described below in reference to FIG. 16 and machine learning and feedback processes described below in Section VI. FIG. 15 illustrates the modules 705, 720, 740, 770, and 780 and storages 710, 730, and 750 described above in reference to FIG. 7. FIG. 15 also illustrates an external reporting system 1510 (i.e., a reporting system that is not part of the clinical data manager 1500), a normalization engine 1520, a feedback module 1530 and a heuristic statistics database 1540.

The external reporting system 1510 passes its output data to the normalization engine 1520. The normalization process performed by the normalization engine of some embodiments is described in subsection V.B below. In some cases, normalization may include scaling the received data, filling-in missing values using pre-defined algorithms, removing data outside of reporting thresholds, and/or other normalization functions.

After normalizing the data from the external reporting system 1510, the normalization engine 1520 may pass the normalized data to the patient database 710 and/or the comparison module 720 depending on whether the data is meant to be stored for the patient's (and/or user's) records, stored for future evaluation, and/or evaluated in real-time. In this manner, critical information (e.g., blood pressure, temperature, etc.) may be acted upon in real-time by the comparison module to identify conditions as they happen. Alternatively, non-critical information (e.g., cholesterol level, etc.) may be stored in the patient database to be acted upon at an appropriate time (e.g., when the attending physician evaluates the patient, if the condition persists for a certain period of time, etc.). In addition, some embodiments may both pass the normalized data to the patient database 710 and the comparison module 720 such that the data may be acted upon in real-time as well as stored for future evaluation or record-keeping.

In some embodiments, inputs received through the user interface (UI) 705 (or passed through other modules) are passed to feedback module 1530 (also referred to as a “machine learning module”). The feedback module monitors user inputs passed from the user interface 705 (e.g., selection of a dashboard from a list) as well as user inputs passed through the condition editing module 770, and/or the dashboard editing module 780. The feedback module 1530 stores the user input data and associated data (e.g., the list of dashboards presented to the user, rules before and after editing, etc.) in a heuristics statistics database 1540. In some embodiments (not shown), the inputs from the UI 705, condition editing module 770, dashboard editing module 780, and/or other modules may be passed directly to the heuristic statistics database 1540 without going through the feedback module 1530.

The feedback module 1530 of some embodiments analyzes the data in the heuristic statistics database 1540 in order to improve the identification of conditions, the recommendation of dashboards, the content of the dashboards, etc., based on the gathered heuristic data. This machine learning aspect of the feedback module 1530 will be described in more detail in Section V below.

As shown, the feedback module 1530 of some embodiments provides its output data to the normalization engine 1520, the rules database 730, the recommendation module 740, the dashboard database 750, and/or the heuristic statistics database 1540. In this manner, the feedback module 1530 is able to improve the performance of these modules as more user feedback is gathered. For instance, the feedback module may determine that doctors generally prefer a certain dashboard while nurses generally prefer a different dashboard when evaluating a particular condition. The recommendation module may use that information to improve the recommendation algorithms used in the future. In this way, the recommendation engine may become more likely to present a user's preferred dashboard(s).

Although software diagram represents the clinical data manager 1500 as implemented on a single device, one of ordinary skill in the art will recognize that some embodiments may be implemented using a combination of devices. For instance, the user interface may be deployed on a user device such as a cellular phone, PDA, PC, etc., while the other functions are performed at a remote server (or servers) that connects to the user device over a network.

B. Normalization of Data from External Reporting Systems

FIG. 16 illustrates the automated normalization process 1600 of some embodiments. As shown, the process begins at 1610 when it receives data from an external reporting system. In some cases, the received data includes data related to the patient (e.g., the patient's blood pressure, glucose level, etc.). The received data may also include externally generated scores (e.g., a sepsis score) that are calculated based on a set of data that is measured by the external system. In other words, the received data is not raw data, but rather is data that has been evaluated by the external system to generate a score based on certain rules, algorithms, and parameters of the external system.

The received data in some cases may include rules related to the external reporting system. For instance, the system may provide a threshold value for blood pressure indicating that the patient has high blood pressure when the threshold is exceeded. As another example, the external system may provide a sepsis score, and a rule that includes a threshold for determining when the patient has sepsis and another limitation such as a minimum time for the threshold to be exceeded (e.g., for a case of sepsis, the received data must exceed the threshold for at least two days to be identified as the condition of sepsis).

As shown, process 1600 continues by matching (at 1615) the received data to an existing rule. Thus, for instance, if the received data is a glucose level, the data may be matched to a rule that determines when a patient has hyperglycemia. The parameters of the existing rule will be used by process 1600 to normalize the external data. For instance, the existing rule may be based on data that has a particular mean value and a particular range of values. As another example, the existing rule may be applied to a set of data that includes various parameters.

Next, the process determines (at 1620) if there is any missing data. When there is missing data, the process uses (at 1630) rules to fill in the missing data. In some cases, the missing data may be caused by gaps in the recorded patient data. For instance, if blood pressure data is typically stored at five minute intervals, missing data may be caused by a failure to report or store the data at a certain interval. In these cases, the normalization process may fill in each missing data point by calculating the mean value of the data points recorded at the intervals before and after the missing data point (if available). Some embodiments may calculate a value for such a missing data point by calculating a linear fit based on a number of data points before and after the missing data value (if available). In some cases the missing data may be filled in based on other algorithms or calculations. Some embodiments may identify missing data values by comparing the received data to the rule identified at 1615. For instance, if the rule requires a glucose value and data indicating whether the patient is over forty years old, the process may retrieve the patient's age from a different source than the external reporting system (which may not have access to data regarding the patient's age).

When there is no missing data, or once the missing data has been filled in, the process continues by scaling (at 1640) the data for use by the system. For instance, the scaling operation could be done using a look-up table that matches input data values from the external system to scaled data values such that the internal system is able to apply existing rules to the external data. In other words, if an external reporting system provides data in a range from 1-250, the scaling operation 1640 may scale the data to a range of 1-100 by matching the data from the external reporting system to an entry in the look-up table, and then selecting the corresponding scaled value from the look-up table. This scaling is done such that an existing rule (identified at 1615) for that type of data may be applied (e.g., the rule defines a condition when a value of the data is greater than 50 on a scale of 1-100).

In some cases, the input data may be scaled using a mathematical operation or formula. For instance, if the external reporting system provides data in a range from 1-500, and the rule is applied to data in a range from 1-100, the input data may be divided by five to generate the scaled output data. In addition, other mathematical operations such as multiplication, addition, and/or subtraction may be used to generate the scaled data. One of ordinary skill in the art will recognize that other mathematical operations or relationships may also be used to scale the data. For instance, a logarithmic function, an exponential function, etc., may be used in the scaling operation. The scaling operation of some embodiments may involve conversion from one system of measurement to another (e.g., from the United States Customary System to the metric system).

After scaling the data, process 1600 continues by determining (at 1650) whether any of the scaled data is above and/or below a reporting threshold (or thresholds). When any of the scaled data does exceed the threshold(s), the process sets (at 1660) that data to the threshold value(s). Thresholds could be set for a variety of reasons. For instance, reporting thresholds may be used to remove outlying and/or invalid data so that the data will not have an undue effect on the evaluation of the patient's condition.

Such reporting thresholds may be based on an expected range of valid data. For example, hypertension (or high blood pressure) may be identified in some cases when a patient's blood pressure is above 140/90, while hypotension (or low blood pressure) may be identified in some cases when a patient's blood pressure is below 90/50. In this example, the reporting thresholds may be set to a minimum value of 70/40 and a maximum value of 170/110. In some embodiments, the thresholds and scaling parameters are set by users, superusers, and/or system administrators. The thresholds and scaling parameters may be based at least partially on the existing rule identified at 1615.

After the process has removed data outside the threshold(s) or determines (at 1650) that no data exceeds the threshold(s), the process continues by determining (at 1670) whether to add the data to the patient database. If so, the data is stored (at 1680) in the patient database. The determination of whether to add the data to the patient database may be based on several factors. For instance, the determination may be based on the amount of storage space available, the existing rule identified at 1615, the time interval since the data was last stored, etc.

Next, the process determines (at 1685) whether to perform real-time evaluation of the data. If so, the data is sent (at 1690) to the rules engine for real-time processing and the process ends. If not, the process ends after storing (at 1680) the data in the patient database. If the process determines (at 1670) that the data will not be added to the patient database, the data is sent (at 1690) to the rules engine for real-time processing and the process ends. In some cases, the rules engine matches the data to existing rules.

### VI. System Learning from User Feedback

In some embodiments, the clinical data manager uses system learning to improve the dashboard recommendation, parameters, etc., based on user feedback. Subsection VI.A describes the collection and analysis of heuristic statistics based on user feedback. Next, subsection VI.B describes a process of receiving user feedback based on a dashboard triggering event, and using that feedback to improve future dashboard triggering operations. Following that discussion, subsection VI.C describes a process of receiving user feedback based on dashboard recommendations, and using the feedback to automatically improve future recommendation operations. Finally, subsection VI.D gives some examples of modified rules, dashboards, and dashboard recommendations based on system learning from user feedback.

A. Heuristic Analysis

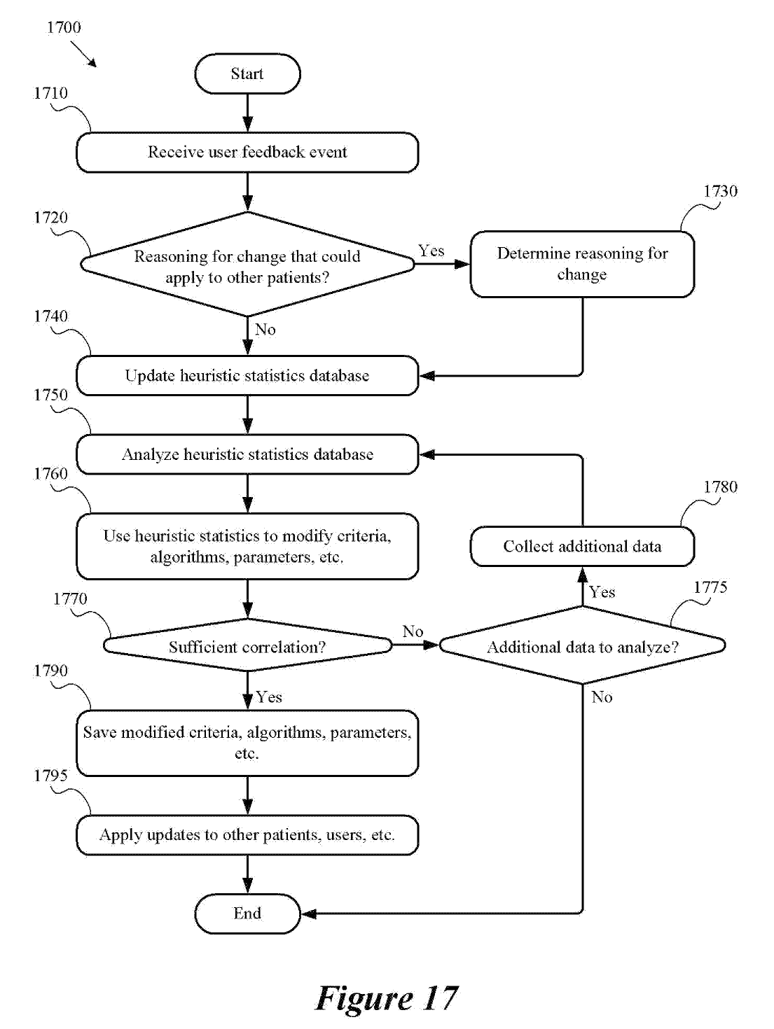

FIG. 17 illustrates an automated process 1700 of some embodiments used to gather and analyze data for the heuristic statistics database and apply the data to future patients. The process begins at 1710 when it receives a user feedback event. A user feedback event may include any type of input from the user. Examples of user feedback events include choosing a particular dashboard from presented options, choosing a dashboard that was not among the presented options, modifying a rule, editing a dashboard or dashboard parameter, modifying a normalization parameter, etc. In some cases, the absence of a user input may also be considered a user feedback event. For instance, if a user is presented with a default dashboard and the user simply accepts the default presentation without making changes to any parameters, the acceptance of the default may be considered feedback just as if the user had selected the dashboard from a list of options.

Next, the process determines (at 1720) if there is a reasoning for the change that could apply to other patients. If so, the process determines (at 1730) the reason for the change. For instance, if a user chooses a particular dashboard in response to a certain condition, the user could be prompted to select a reason for choosing that dashboard. The reasoning may be selected from a pull-down menu, or other list of choices in some embodiments. For instance, a user may raise the temperature threshold that is used to determine when a patient has a fever. This threshold may be raised based on the knowledge that the patient has an infection, which can cause the patient's temperature to be higher than normal. Thus, in this circumstance the user may select, from a pull-down menu, a reason for the change such as “patient has infection”. In this example, the user has selected a condition as a reason for the change. In these cases, the process may map the reasoning to a rule, such that the rule may be applied to other patients. For example, the “patient has infection” condition criteria may be mapped to a rule such as “culture positive”.

Whether the user enters a reason for the event or not, the event (and the reasoning, if available) is automatically stored (at 1740) in the heuristic statistics database. For instance, if a doctor selects a particular dashboard based on a combination of conditions, both the conditions and the selected dashboard could be stored. In addition, data about the doctor (or other user), patient and/or other data may be stored. For instance, if the doctor is a cardiologist, that information may be stored as her feedback may be found to be more applicable to other cardiologists than to doctors with other specialties. As another example, data such as the patient's age and/or gender may be stored so that the user feedback can be evaluated in relation to that patient data, and thus be more effectively applied to other patients.

Next, the process analyzes (at 1750) the heuristic statistics database. The analysis may include statistical analysis of the dashboards and features that are presented to the users versus the users' choices or edits. For instance, the statistical analysis could identify a correlation between a combination of conditions and users selecting a modified dashboard instead of the default presentation. In some embodiments (not shown), the analysis (and subsequent operations) may be performed after a certain number of user events, at a particular time interval, or based on other criteria.

In some embodiments, the analysis divides the users (or patients, conditions, etc.) into sub-groups. These sub-groupings may be based on a variety of factors. In many cases, the sub-groups are based on user or patient data. For instance, all cardiologists may be designated as members of a sub-group. In addition, the sub-groups may be further refined to include sub-groups within the sub-groups. Thus, for instance, a sub-group of the sub-group of cardiologists may be cardiologists working in the ICU. The sub-groups may be based on whatever factors are deemed appropriate. Thus, some embodiments select a sub-group based on factors such as the doctor's specialty, the patient's diagnosis, the area of the hospital, etc.

After dividing the users into sub-groups, some embodiments select a sub-group for evaluation. The evaluation begins by retrieving the data associated with the current sub-group. Next, input data points are selected for the algorithm being analyzed. Thus, for instance, when the system learning process is evaluating the relative popularity of a particular dashboard, the input data could include any patient or user data that is relevant to the recommendation of the particular dashboard.

In some embodiments, after selecting the input data points, the associated outputs for the selected input data points are retrieved. In some embodiments, the outputs would be a measure of what percentage of the users selected the recommended dashboard (or other parameter under evaluation). Some embodiments may use a measure of the patient's progress as an associated output. The analysis of this data may entail different types of statistical evaluation. For instance, some embodiments may use regression analysis to determine the correlation between the measured and predicted output data generated using the modified selection algorithm. Regression analysis is a collective term for techniques used to model and analyze numerical data consisting of values of a dependent variable (i.e., the associated outputs) and of one or more independent variables (i.e., the input data points).

In some embodiments, certain feedback may be weighed more heavily during the statistical analysis depending on the source of the feedback. For instance, feedback from more senior doctors, experienced nurses, department leaders, etc. may have a greater effect on the outcome of the analysis than feedback from more junior doctors, less-experienced nurses, etc. Some embodiments may only consider feedback from users that meet certain threshold criteria. For instance, some embodiments may consider only feedback from doctors with more than three years experience when evaluating the heuristic statistics database. As another example, some embodiments may only consider feedback from users who work in a particular department (e.g., a dashboard that was specifically developed for use in the ICU may be evaluated solely based on feedback from users assigned to the ICU).

After analyzing the data, the process uses the statistical information to modify (at 1760) the dashboard selection criteria, normalization operations, rule definition, and/or other system algorithms and/or parameters. For instance, if a number of users prefer a modified dashboard to a default dashboard, the recommendation algorithm may become more likely to present the modified dashboard, or even make the modified dashboard the default. In some embodiments, the updates may be reviewed by a system administrator or other user before being implemented. Some embodiments may apply aspects of machine learning to all users (e.g., when a majority of users prefer a particular dashboard, that dashboard may become more highly recommended). Other embodiments may apply aspects of machine learning only to individual users or patients (e.g., if a particular user never chooses a certain dashboard, that dashboard may become less likely to be recommended to that particular user but may not affect the recommendations offered to other users).

After modifying (at 1760) the algorithms or other parameters, the system of some embodiments determines (at 1770) whether there is sufficient correlation between the predicted and previously measured output data to verify that the modified algorithm is valid. This correlation may be measured using different means of statistical analysis. For instance, a modified algorithm may be deemed to have sufficient correlation when a measure of the goodness-of-fit of the predicted versus measured output data (i.e., a measure of how well future outcomes are likely to be predicted by the modified algorithm) exceeds a certain threshold. For example, a “coefficient of determination”, R², may be compared to a threshold to determine when the modified algorithm has sufficient correlation. The coefficient of determination represents the proportion of variability in a data set that is accounted for by a statistical model.

When there is not sufficient correlation between the predicted and measured output data, some embodiments may determine (at 1775) whether there are additional data to analyze. When the process determines that there is additional data to analyze, the process collects (at 1780) additional data and repeats the operations 1750-1780 until the process determines (at 1770) that there is sufficient correlation between the predicted and previously measured output data or the process determines (at 1775) that there is no additional data to analyze. When the process determines (at 1770) that the modified algorithms, etc. do not have sufficient correlation and further determines (at 1775) that there is no additional data to analyze, the modified algorithms, etc. are not saved and the process ends.

In some cases, the additional input data points may be generated by expanding the sub-group being examined. For example, when there is insufficient correlation for a model based on cardiologists in the ICU, process 1900 may expand the sub-group to include cardiologists working in other areas. In other cases, the additional input data points may be gathered from existing data that was not originally selected in order to improve computational efficiency. In some instances, there may be no additional input data points that are meaningful in regard to the current algorithm, and the additional input data points will be obtained over time as more users access the system and more data is created and stored. In any case, after additional input data points are selected, the system continues analyzing (at 1750) the data, modifying (at 1760) the algorithms, etc., and/or collecting (at 1780) additional data points until the modified algorithm provides sufficient correlation between the predicted and measured output values or there is no additional data to analyze.

When the system determines (at 1770) that there is sufficient correlation, the modified algorithm, etc. is saved (at 1790) so that the modified algorithm, criteria, parameter, etc. may be applied (at 1795) to other patients, users, etc., at which point the process ends. In this manner, the system is able to automatically improve the recommendation algorithms over time and apply those improvements to other patients and the system users (e.g., doctors and nurses) who serve them. Next, if all sub-groups have not been analyzed, the other sub-groups may be analyzed in the same manner to that described above. Once the system has analyzed all sub-groups, the analysis is complete.

In some embodiments, the system will repeat the heuristic analysis at regular intervals (or continuously). In some embodiments, the process will be repeated when enough new data has been collected to re-evaluate the various algorithms. For instance, the algorithms used for cardiologists may be updated when the number of data points from cardiologists reaches certain thresholds (e.g., the algorithms may be updated when the system has identified 100 new interactions with users who are cardiologists since the last update).

When applying the updates to other patients and system users, some embodiments identify sub-groups applicable to the current user and/or patient. For instance, the current patient may be identified with the sub-group of people with high blood pressure. Next, an algorithm associated with the sub-group is identified. The algorithm could be used to recommend a dashboard based on patient data, user data, etc. In addition, the system may determine whether the user (or patient) is associated with any other sub-groups. The algorithm may then be further refined based on data relating to the other sub-groups, if applicable. For example, the dashboard recommendation algorithm may be different for a patient with high blood pressure who is also over age sixty than for a patient with high blood pressure who is under sixty.

B. Dashboard Triggering and Feedback

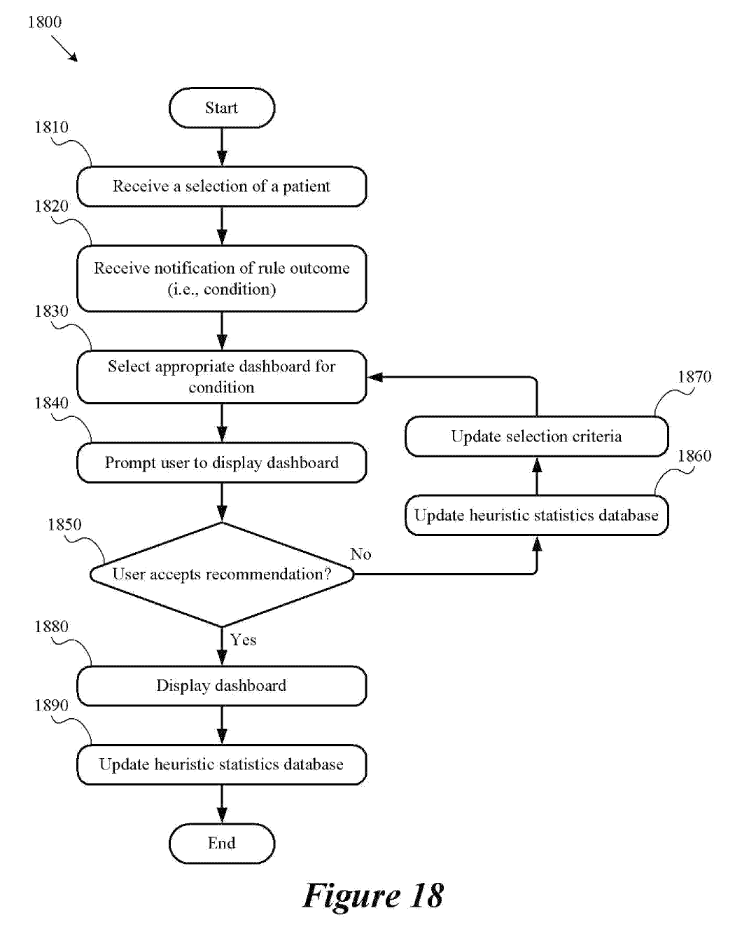

FIG. 18 illustrates an adaptive, automated process 1800 for triggering a dashboard. In some instances, a certain dashboard may be so likely to be preferred by a particular user that the system will offer the dashboard without prompting the user to make a selection from a list of dashboards. As shown, the process begins at 1810 when it receives a selection of a patient from a user. In some embodiments this selection may be done automatically or by default. For instance, certain patient monitoring and reporting systems may only be connected to a single patient.

Next, the process receives (at 1820) a notification of a rule outcome (i.e., a condition). For instance, the process may receive a notification that the selected patient's glucose has been greater than 130 mg/dL for an extended period of time, indicating hyperglycemia. The process then selects (at 1830) an appropriate dashboard for the identified condition. For instance, in the example given above, the process chooses the default dashboard for hyperglycemia. Other examples of conditions that may influence the triggering of a dashboard include, for instance, the specialty of the patient's primary physician (e.g., primary physician's specialty=“neurosurgeon”, “cardiologist”, etc.) or notification that the patient's temperature is greater than 37.5° C., indicating a low grade fever. These conditions may then trigger a particular dashboard to be displayed. For example, a particular dashboard (e.g., “fever_neuro”) may be recommended if the conditions include the fact that the primary physician is a neurosurgeon and the notification that a patient's temperature is greater than 37.5° C.

After the process selects (at 1830) a dashboard, the process prompts (at 1840) the user to display the selected dashboard. In some cases, this operation is skipped, and the default dashboard is displayed without any prompt. In some cases the prompt may include a pop-up window that asks “Would you like to display the recommended dashboard?”, with the choices of “yes” and “no” available as response buttons in the pop-up window. In other cases, the prompt may be supplied in a pane of the graphical user interface (“GUI”). Next, process 1800 determines (at 1850) whether the user has accepted the recommendation. In some embodiments, the user may indicate that she has accepted the recommendation by, for example, clicking “yes” when prompted with the pop-up window described above. When the dashboard has been automatically displayed without any prompt, the user may indicate her acceptance of the recommendation by doing nothing (i.e., when the user does not select a different dashboard than the automatically displayed dashboard, thus impliedly accepting the recommended dashboard).

When the process determines (at 1850) that the user does not accept the recommendation, the process updates (at 1860) the heuristic statistics database with the relevant information. In this case, the relevant information includes the fact that the recommended dashboard was not selected by the user, as well as other information about the user and/or patient, etc. For instance, if the user is a nurse assigned to the ICU, that information may be stored as her feedback may be found to be more applicable to other ICU nurses than to nurses assigned to other units (or to other users such as physicians). As another example, data such as whether the patient has high blood pressure may be stored so that the user feedback can be evaluated in relation to that patient data, and thus be more effectively applied to other patients.

Next, the process updates (at 1870) the selection criteria based on the updates to the heuristic statistics database. The process then repeats operations 1830-1870 as necessary until the process determines (at 1850) that the user accepts the recommended dashboard. At that point, the dashboard is displayed (at 1880), the process updates (at 1890) the heuristics statistics database with the relevant information, and the process ends.

In some cases, the process may determine (at 1850) that a user accepts a recommended dashboard, but then determines that the user has modified parameters (e.g., different data in a pane, a graph versus a table, etc.). In these instances, the heuristics statistics database is updated and analyzed by process 1700 using information reflecting the changes made by the user, as well as the fact that the user accepted the recommended dashboard, etc.

C. Adaptive Dashboard Recommendation and Feedback

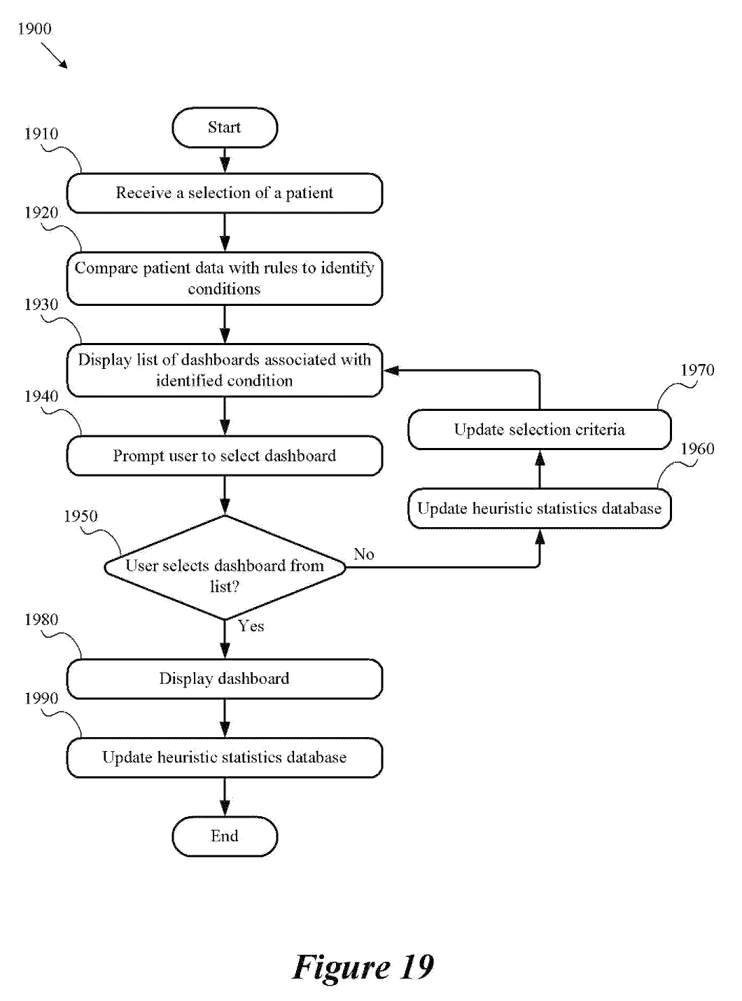

FIG. 19 illustrates an automated dashboard recommendation process 1900 with feedback of some embodiments. FIG. 19 will be described with reference to the dashboard triggering process 1800 described above. As shown, process 1900 begins at 1910 when a selection of a patient is received. Next, the process compares the patient's data to a set of rules in order to identify (at 1920) any conditions the patient has. Thus, for instance, the patient's glucose levels could be compared to an upper threshold where exceeding the threshold indicates hyperglycemia. As another example, the patient's temperature could be compared to a threshold where exceeding the threshold indicates a low grade fever. In addition to (or in place of) threshold comparisons, the patient's data may be evaluated by determining if a certain piece of data matches a rule for a condition (e.g., when the condition is whether the patient's primary physician is a neurosurgeon).

The patient's data may be compared to a set of rules in some embodiments, where the set of rules may be partially based on the patient's data. For instance, data corresponding to a patient who is in the ICU and is known to be diabetic may be compared to a particular set of rules, while data corresponding to a patient who is in the ICU but is not known to be diabetic may be compared to a second set of rules. In some cases, the set of rules will be a set of default rules, if no relevant information is known about the patient. A patient's data may also be compared to all available rules in some cases.

The process then displays (at 1930) a list of dashboards associated with one or more identified conditions. In some embodiments, the displayed list may be based on a combination of factors used to recommend dashboards for a particular user and patient. The factors could include the patient's identified condition(s), the patient's medical history, the ward of the hospital that the patient is admitted to, the user's status (e.g., nurse, doctor, etc.), and/or other factors.

When no conditions are identified (e.g., when the patient's data is within all identified thresholds or doesn't match any comparison criteria), the process displays a default list of dashboards. The default list may be based on different factors related to the user, the area of the hospital, and/or other factors. For instance, nurses may be presented with a different default list of dashboard than doctors. As another example, a cardiologist may be presented with a different default list of dashboards than a neurologist, even based on the same underlying patient data.

The display of a default list of dashboards when no conditions are identified is in contrast to process 1800 where a dashboard is only triggered when notification of a condition is received (at 1820), otherwise dashboard triggering is not applicable. In these instances, the dashboard recommendation process 1900 would be used to display a list of dashboards. The list of dashboards may be a default list if no conditions have been identified (at 1920) or if multiple conditions are identified. In some cases, a single condition may also generate a list of dashboards rather than triggering a particular dashboard as described in process 1800, at operation 1830.

After process 1900 displays (at 1930) the list of dashboards (either the default list or a list based on identified conditions), the process prompts (at 1940) the user to select a dashboard from the list. The prompt may include a list of selections in a window pane of the GUI, a pop-up window that displays the list of default dashboards, or some other appropriate means. The process then determines (at 1950) whether the user has selected a dashboard from the list of dashboards. In some cases, the user may make the selection via a mouse click or appropriate keyboard sequence.

The user may decline to select any of the dashboards displayed in the list. In a similar manner to operations 1830-1870 of process 1800, when process 1900 determines (at 1950) that the user has not selected a dashboard from the list, the heuristic statistics database is updated (at 1960). The heuristic statistics database may be updated with information such as the list of dashboards presented to the user, data about the user and/or patient, etc. Next, the selection criteria is updated (at 1970) and an updated list of dashboards is displayed (at 1930) based on the modified criteria.

In some cases, the displayed list of dashboards may be updated by providing the next group of dashboards in a pre-existing list of potential dashboards. For instance, if the process originally displayed the first five dashboards in the list of potential dashboards, and the user does not select one, the process may recommend the next five dashboards in the list of potential dashboards (i.e., the dashboards ranked sixth through tenth). If one or more conditions were identified, the list of potential dashboards may be based at least partially on the identified condition(s). If no conditions were identified, the list of potential dashboards may be a pre-determined list of default dashboards in some embodiments.

In other cases, the selection criteria itself may be changed when the user does not choose from the provided list. For instance, in some embodiments the process may alter the recommendation algorithm by attempting to match the patient or user to a different sub-group than that identified in the previous recommendation. For example, if a default list of dashboards was originally recommended based on the fact that the user is a cardiologist, the next list of recommended dashboards may be based on the fact that the user is working in the ICU. Operations 1930-1970 are then repeated until the process determines (at 1950) that the user has selected a dashboard from the displayed list.

Once the process determines (at 1950) that the user has selected a dashboard from the displayed list, the process continues by displaying (at 1980) the selected dashboard. The heuristic statistics database is then updated (at 1990), and the process ends. These operations are performed in a similar manner to those described above in reference to process 1800, operations 1850, 1880, and 1890.

Alternatively to repeatedly performing operations 1930-1970 when the process determines (at 1950) that a user does not select a dashboard from the displayed list, the process may allow a user to simply forego the recommendation process and make his own selection. In this case, the user may make a selection by browsing a list of all available dashboards, or some other appropriate means. When the user makes a selection in this manner, process 1700 may be used to update and analyze the heuristic statistics database based on the user feedback event. In addition, process 1700 may be used if the user selects a dashboard from the displayed list but then modifies the dashboard's content or other parameters.

D. Examples of Adapted Dashboard Recommendation

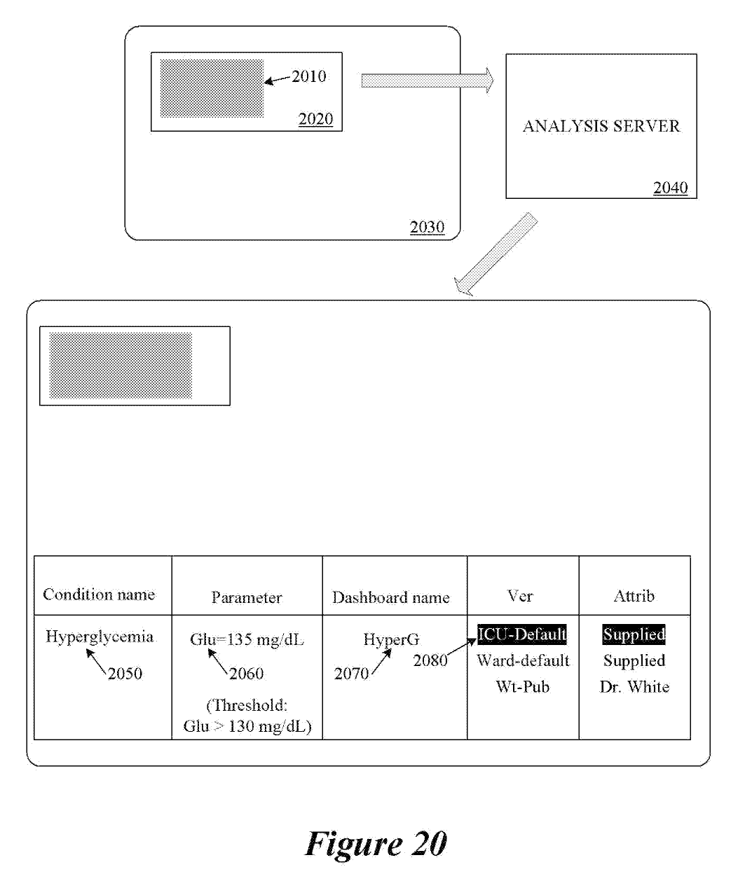

FIGS. 20-22 illustrate the modification of a list of recommended dashboards based on automated, adaptive learning of some embodiments as described above in reference to process 1700. FIG. 20 illustrates a graphical user interface of some embodiments for providing recommendations after a dashboard triggering event. As shown, a patient 2010 is selected from a list 2020 of patients using the user interface 2030. The selection is passed to the analysis server 2040. The analysis server 2040 may include several modules described earlier in reference to the clinical data manager 1500. For instance, the analysis server may include the recommendation module 740, the comparison module 720, the feedback module 1530, etc. In addition, the analysis server 2040 may have access to the patient database 710, the rules database 730, the dashboard database 750, the heuristic statistics database 1540, and/or other data stored by the clinical data manager 1500.

In this example, the analysis server 2040 has determined that the patient 2010 has hyperglycemia 2050, as indicated by a glucose level greater than 130 mg/dL 2060. Based on the identified condition 2050, the analysis server 2040 has recommended the HyperG dashboard 2070. In addition, the recommended version is the ICU-Default dashboard 2080.

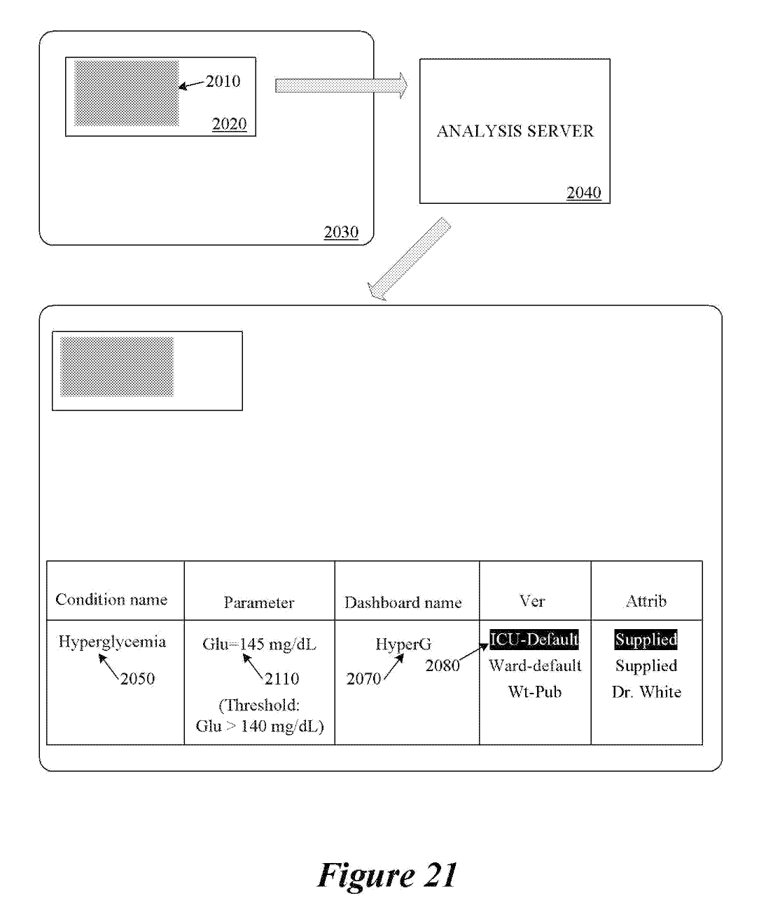

FIG. 21 illustrates the graphical user interface of FIG. 20 after machine learning due to user feedback. In this example, the threshold (i.e., the rule) for glucose has been increased from 130 mg/dL to 140 mg/dL based on the feedback from users of the system. Thus, the analysis server identifies the same condition 2050, recommended dashboard 2070, and dashboard version 2080 as shown in FIG. 20. In this example, however, the patient's 2010 glucose level 2110 is higher than the example of FIG. 20 because the threshold has been increased such that the dashboard recommendation would not be triggered until the patient's 2010 glucose level is above 140 mg/dL.

This change may be based solely on heuristic statistics and implemented using machine learning. For instance, when a majority of users have declined the system's recommendation of the hyperglycemia dashboard when glucose levels are below 140 mg/dL but accepted the recommendation when the glucose levels are above 140 mg/dL, the system may use that feedback to increase the threshold used to trigger that condition.

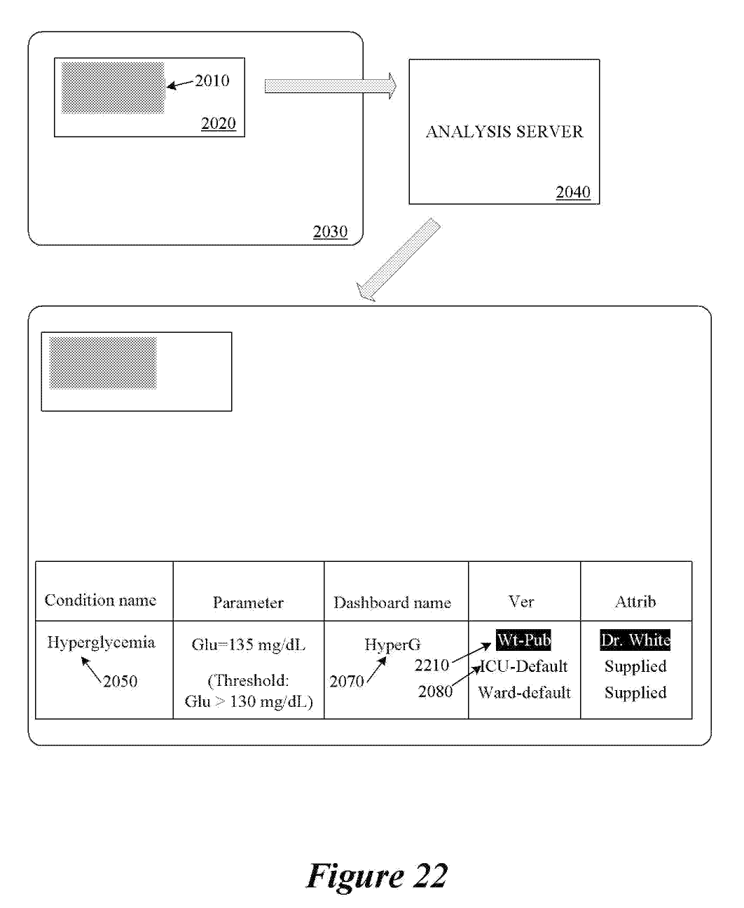

FIG. 22 illustrates the graphical user interface of FIG. 20 after machine learning due to user feedback. In this example, the order of recommended dashboards has been changed based on the feedback from users of the system. As shown, the same condition 2050 and dashboard 2070 are recommended for the selected patient 2010. However, instead of the ICU-Default dashboard version 2080 being offered as the first choice, the Wt-Pub dashboard version 2210 is offered as the user's first choice. The Wt-Pub dashboard version may differ from the ICU-Default dashboard version 2080 in several ways. For instance, trends over time may be displayed as a graph in one dashboard version versus a table in a different dashboard version. As another example, one dashboard version may display different variables (e.g., a graph of O2 versus time instead of a graph of glucose levels over time) than a different dashboard version. In some cases, one dashboard version may display multiple representations of data related to a certain variable (e.g., a graph of glucose levels versus time and a table of glucose levels over time instead of only a graph of glucose levels over time) as compared with a different dashboard version.

The change in order of recommended dashboards may be based solely on heuristic statistics and implemented using machine learning in some embodiments. For instance, when a majority of users have selected the Wt-Pub dashboard version 2210 when prompted by the system, the system may automatically alter the recommendation algorithm such that the Wt-Pub dashboard version 2210 is more highly recommended than the ICE-Default dashboard version 2080 even with the same user, patient, and identified condition.

### VII. Alternate Embodiments

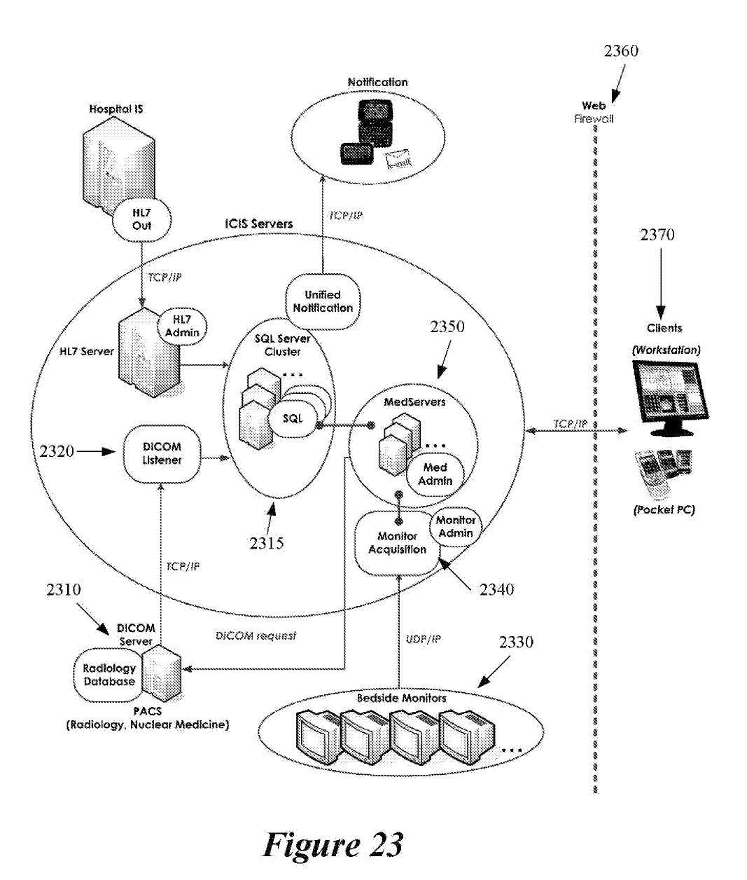

In some embodiments, such as the one illustrated in FIG. 23, the patient data is sent to the patient database through other servers, databases or subsystems, such as radiology database 2310, which stores radiology data (e.g. scanner images) and sends them to the patient database 2315 through DICOM listener 2320, or bedside monitors 2330 which send data to the patient database 2315 through monitor acquisition subsystem 2340 and medical servers 2350. FIG. 23 also illustrates that the system can send and receive data from outside the system (e.g. over the Internet) through a firewall 2360 to workstations and/or pocket PCs 2370.

One of ordinary skill in the art will realize that some embodiments exist as computer programs stored on computer readable media. Such computer programs include sets of instructions that allow the program to perform the methods and provide the interfaces described in this application. One or more of the machines described in FIG. 23 and in the figures described above may include such computer readable media (e.g. memory, drives, etc.) and store programs with instructions to perform one or more operations of the processes described herein. Accordingly, a computer readable medium that includes such a program is within the scope of the present invention.

### VIII. Computer System

Many of the above-described processes and modules are implemented as software processes that are specified as a set of instructions recorded on a computer readable storage medium (also referred to as “computer readable medium” or “machine readable medium”). When these instructions are executed by one or more computational element(s) (such as processors or other computational elements like ASICs and FPGAs), they cause the computational element(s) to perform the actions indicated in the instructions. Computer is meant in its broadest sense, and can include any electronic device with a processor. Examples of computer readable media include, but are not limited to, CD-ROMs, flash drives, RAM chips, hard drives, EPROMs, etc.

In this specification, the term “software” is meant in its broadest sense. It can include firmware residing in read-only memory or applications stored in magnetic storage which can be read into memory for processing by a processor. Also, in some embodiments, multiple software inventions can be implemented as sub-parts of a larger program while remaining distinct software inventions. In some embodiments, multiple software inventions can also be implemented as separate programs. Finally, any combination of separate programs that together implement a software invention described here is within the scope of the invention. In some embodiments, the software programs when installed to operate on one or more computer systems define one or more specific machine implementations that execute and perform the operations of the software programs.

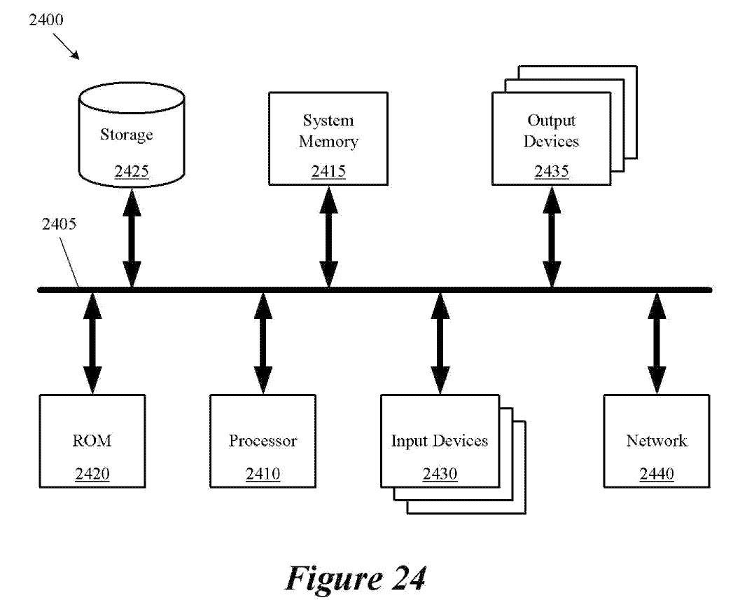

FIG. 24 illustrates a computer system 2400 with which some embodiments of the invention are implemented. For example, the various systems described above in reference to FIGS. 1, 5, 7, 15, and 23 may be at least partially implemented using sets of instructions that are run on the computer system 2400. As another example, the processes described in reference to FIGS. 4, 8, 10, and 16-19 may be at least partially implemented using sets of instructions that are run on the computer system 2400.

Such a computer system includes various types of computer readable mediums and interfaces for various other types of computer readable mediums. Computer system 2400 includes a bus 2405, a processor 2410, a system memory 2415, a read-only memory (ROM) 2420, a permanent storage device 2425, input devices 2430, output devices 2435, and a network connection 2440. The components of the computer system 2400 are electronic devices that automatically perform operations based on digital and/or analog input signals. The various examples of user interfaces shown in FIGS. 3a, 3b, 6, 9, 12, 14, and 20-22 may be at least partially implemented using sets of instructions that are run on the computer system 2400 and displayed using the output devices 2435.

One of ordinary skill in the art will recognize that the computer system 2400 may be embodied in other specific forms without deviating from the spirit of the invention. For instance, the computer system may be implemented using various specific devices either alone or in combination. For example, a cellular phone or PDA may include the input and output devices 2430 and 2435, while a remote PC may include the other devices 2405-2425, with the cellular phone or PDA connected to the PC through a cellular network that accesses the PC through its network connection 2440.

The bus 2405 collectively represents all system, peripheral, and chipset buses that communicatively connect the numerous internal devices of the computer system 2400. For instance, the bus 2405 communicatively connects the processor 2410 with the read-only memory 2420, the system memory 2415, and the permanent storage device 2425. From these various memory units, the processor 2410 retrieves instructions to execute and data to process in order to execute the processes of the invention. In some cases, the bus 2405 may include wireless and/or optical communication pathways in addition to or in place of wired connections. For example, the input and/or output devices may be coupled to the system using a wireless local area network (W-LAN) connection, Bluetooth®, or some other wireless connection protocol or system.

The read-only-memory (ROM) 2420 stores static data and instructions that are needed by the processor 2410 and other modules of the computer system. The permanent storage device 2425, on the other hand, is a read-and-write memory device. This device is a non-volatile memory unit that stores instructions and data even when the computer system 2400 is off. Some embodiments of the invention use a mass-storage device (such as a magnetic or optical disk and its corresponding disk drive) as the permanent storage device 2425.

Other embodiments use a removable storage device (such as a floppy disk, flash drive, or CD-ROM) as the permanent storage device. Like the permanent storage device 2425, the system memory 2415 is a read-and-write memory device. However, unlike storage device 2425, the system memory is a volatile read-and-write memory, such as a random access memory (RAM). The system memory stores some of the instructions and data that the processor needs at runtime. In some embodiments, the sets of instructions used to implement invention's processes are stored in the system memory 2415, the permanent storage device 2425, and/or the read-only memory 2420.

The bus 2405 also connects to the input and output devices 2430 and 2435. The input devices enable the user to communicate information and select commands to the computer system. The input devices 2430 include alphanumeric keyboards and pointing devices (also called “cursor control devices”). The input devices 2430 also include audio input devices (e.g., microphones, MIDI musical instruments, etc.) and video input devices (e.g., video cameras, still cameras, optical scanning devices, etc.). The output devices 2435 include printers, electronic display devices that display still or moving images, and electronic audio devices that play audio generated by the computer system. For instance, these display devices may display a GUI. The display devices include devices such as cathode ray tubes (“CRT”), liquid crystal displays (“LCD”), plasma display panels (“PDP”), surface-conduction electron-emitter displays (alternatively referred to as a “surface electron display” or “SED”), etc. The audio devices include a PC's sound card and speakers, a speaker on a cellular phone, a Bluetooth® earpiece, etc. Some or all of these output devices may be wirelessly or optically connected to the computer system.

Finally, as shown in FIG. 24, bus 2405 also couples computer 2400 to a network 2440 through a network adapter (not shown). In this manner, the computer can be a part of a network of computers (such as a local area network (“LAN”), a wide area network (“WAN”), or an Intranet, or a network of networks, such as the internet. For example, the computer 2400 may be coupled to a web server (network 2440) so that a web browser executing on the computer 2400 can interact with the web server as a user interacts with a GUI that operates in the web browser.

As mentioned above, the computer system 2400 may include one or more of a variety of different computer-readable media (alternatively referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, read-only and recordable blu-ray discs, ultra density optical discs, any other optical or magnetic media, and floppy disks. The computer-readable media may store a computer program that is executable by at least one processor and includes sets of instructions for performing various operations.

For the purposes of this Specification, a computer is a machine and the terms display or displaying mean displaying on an electronic device. It should be recognized by one of ordinary skill in the art that any or all of the components of computer system 2400 may be used in conjunction with the invention. Moreover, one of ordinary skill in the art will appreciate that any other system configuration may also be used in conjunction with the invention or components of the invention.

While the invention has been described with reference to numerous specific details, one of ordinary skill in the art will recognize that the invention can be embodied in other specific forms (i.e., different embodiments may implement or perform different operations) without departing from the spirit of the invention. For example, while the examples shown illustrate many individual modules as separate blocks (e.g., the condition editing module 770, the dashboard editing module 780, etc.), one of ordinary skill in the art would recognize that some embodiments may combine these modules into a single functional block or element. One of ordinary skill in the art would also recognize that some embodiments may divide a particular module into multiple modules. In addition, although the examples given above may discuss accessing the system using a particular device (e.g., a PC), one of ordinary skill will recognize that a user could access the system using alternative devices (e.g., a cellular phone, PDA, smartphone, BlackBerry®, or other device).

One of ordinary skill in the art will realize that some of the features described in this application are present in prior art (e.g. different permission levels for different users), however, they have not been used in combination with other features described herein. Furthermore, while the invention has been described with reference to numerous specific details, one of ordinary skill in the art will recognize that the invention can be embodied in other specific forms without departing from the spirit of the invention. For instance, alternate embodiments may allow more or fewer types of variables to affect recommendations. One of ordinary skill in the art would understand that the invention is not to be limited by the foregoing illustrative details, but rather is to be defined by the appended claims.

We claim:

1. An automated method of collecting a user's feedback in response to a dashboard recommendation, said method comprising:
a) providing a recommendation of at least one dashboard to the user based at least partially on a set of associated recommendation criteria;
b) receiving a user feedback event based on the recommendation; and
c) storing the user feedback event and associated recommendation criteria for use in providing future dashboard recommendations.

2. The automated method of claim 1, wherein the associated recommendation criteria comprises a set of user data.

3. The automated method of claim 1, wherein the associated recommendation criteria comprises a set of patient data.

4. The automated method of claim 1, wherein the associated recommendation criteria comprises one or more identified patient conditions.

5. The automated method of claim 1, wherein the recommendation comprises a list of recommended dashboards.

6. The automated method of claim 5, wherein the user feedback event comprises the user selecting a recommended dashboard from the list of recommended dashboards.

7. The automated method of claim 1, wherein the recommendation comprises a particular recommended dashboard.

8. The automated method of claim 7, wherein the user feedback event comprises the user selecting the particular recommended dashboard.

9. The automated method of claim 7, wherein the user feedback event comprises the user selecting a dashboard other than the particular recommended dashboard.

10. The automated method of claim 7, wherein the user feedback event comprises a modification of the particular recommended dashboard.

11. The automated method of claim 1, wherein the dashboard recommendation is triggered when a particular parameter, from a set of patient data, exceeds a threshold.

12. The automated method of claim 11, wherein the particular parameter comprises body temperature.

13. The automated method of claim 12, wherein the user feedback event comprises the user increasing the threshold for a particular patient when the particular patient is determined to have an infection.

14. An automated method of analyzing user feedback in response to a set of dashboard recommendations, said method comprising:
a) providing a first recommendation of at least one dashboard to a first user at least partially in response to a first set of associated recommendation criteria;
b) receiving a set of user feedback events based on the recommendation;
c) receiving a second set of recommendation criteria that is similar to the first set; and
d) based on the set of user feedback events, providing a second recommendation of at least one dashboard to a second user at least partially in response to the second set of recommendation criteria.

15. The automated method of claim 14, wherein the second recommendation is different than the first recommendation.

16. The automated method of claim 14, wherein the first user and the second user are different users.

17. The automated method of claim 14, wherein the first user and the second user are the same user.

18. A computer readable storage medium storing a computer program which when executed by at least one processor normalizes medical input data points, the computer program comprising:
a set of instructions for receiving a plurality of medical input data points from an external reporting system, the data points for use in a medical dashboard recommendation system;
a set of instructions for generating a scaled output data point corresponding to each of a plurality of medical input data points; and
a set of instructions for storing each scaled output data point.

19. The computer readable storage medium of claim 18,
wherein the plurality of medical input data points have a particular range of values,
wherein the set of instructions for generating a scaled output data point corresponding to each of said input data points comprises using a look-up table to match each input data point to a corresponding scaled output data point,
wherein the look-up table comprises an entry for each input data value in the particular range of values and a corresponding scaled data value for each particular input data value.

20. The computer readable storage medium of claim 18, wherein the set of instructions for generating a scaled output data point corresponding to each of said input data points comprises using a mathematical formula to calculate each output data point based on a particular input data point.

21. The computer readable storage medium of claim 18, wherein the set of instructions for generating a scaled output data point corresponding to each of said input data points comprises converting each of said input data points in a first system of measurement to a scaled output data point in a second system of measurement.

22. The computer readable storage medium of claim 18 further comprising: a set of instructions for determining that necessary data values are missing from the input data points; and
a set of instructions for calculating the missing necessary data values based on the input data points and a set of rules.

23. The computer readable storage medium of claim 18 further comprising:
a set of instructions for comparing each of the input data points to a first threshold;
a set of instructions for determining when each of the input data points is above the first threshold; and
a set of instructions for setting each corresponding scaled output value to the first threshold when the input data point exceeds the first threshold.

24. The computer readable storage medium of claim 23 further comprising:
a set of instructions for comparing each of the input data points to a second threshold;
a set of instructions for determining when each of the input data points is below the second threshold; and
a set of instructions for setting each corresponding scaled output value to the second threshold when the input data point exceeds the second threshold.
